(19) United States
(12) Patent Application Publication
(10) Pub. No.: US 2015/0234377 A1
(43) Pub. Date: Aug. 20, 2015

(54) CONSTRUCTION MANAGEMENT SYSTEM

(71) Applicant: ResiWeb Limited, Rocklea (AU)

(72) Inventor: Lev Mizikovsky, Petrie Terrace (AU)

(21) Appl. No.: 14/624,367

(22) Filed: Feb. 17, 2015

(30) Foreign Application Priority Data
Feb. 18, 2014 (AU) 2014900509

(51) Int. Cl. G05B 19/4097; G06F 17/50

(52) U.S. Cl. CPC G05B 19/4097; G06F 17/5004

(57) ABSTRACT

A method for managing a construction project, wherein the method includes, in one or more electronic processing devices: for a selected standard construction design, retrieving a construction model for the standard construction design from a store, the construction model including a plurality of material elements representing materials for use in carrying out a construction project in accordance with the construction model, each material element having material properties including construction attributes; determining one or more design customisations; updating the construction model in accordance with the one or more design customisations to thereby generate a customised construction model, by at least one of adding one or more material elements, removing one or more material elements, and modifying one or more material elements; and generating construction information associated with carrying out the construction project in accordance with the construction attributes of the customised construction model.

### CLAIM OF PRIORITY

This application claims the benefit of priority under 35 U.S.C. §119 to Australian Patent Application No. 2014900509, filed on Feb. 18, 2014, which is hereby incorporated by reference herein in its entirety.

### BACKGROUND OF THE INVENTION

The present invention relates to methods and systems for use in the management of construction projects, being particularly suitable for construction projects which involve customisations from standard designs, such as for the construction of project homes or the like.

### DESCRIPTION OF THE PRIOR ART

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

Project home construction companies build large numbers of new homes based on standard designs and plans, and these companies are able to offer highly competitive pricing compared to custom or one-off designs due to standardisation of the construction project and resulting efficiencies of scale.

Whilst project home construction companies will typically offer a variety of standard designs and plans to cater for different tastes and budgets, customers will still often require at least some customisations from a selected standard design. These customisations may be needed to incorporate desired options that are not included in the selected standard design, or to accommodate a particular block of land upon which the home is to be built. It is noted that similar customisations may apply in any construction project with specific site requirements.

In the case of a building construction project, such customisations need to be accounted for in the final plan, cost estimate and schedule for carrying out the building construction project, but this is not necessarily a straightforward matter and has traditionally required substantial manual effort. Accordingly, customisations can have a negative impact on the pricing competitiveness of a project home and can carry significant additional costs and an increased administrative burden.

A range of software packages exist for facilitating the management of different aspects of construction projects, such as estimating and scheduling software. However, whilst existing software packages can be successfully used in managing construction projects of significant complexity, these are not particularly well suited for project home building projects, or similar projects including customisations from a standard design. This is because separate estimates and schedules will generally need to be prepared and maintained for each building project, removing some of the advantages of using the standard design. Software packages will generally be operated independently, thus requiring further manual effort to ensure the correct and most up-to-date design information is coordinated across each software package.

US 2006/0074608 A1 discloses a system and method for designing and scheduling building construction. The system includes a three dimensional design system that generates three dimensional design data using one or more elements in a spatial tree structure. One or more recipes are associated with each element, where each recipe has one or more associated method components and each method component has one or more associated resource components. A cost estimate system generates cost estimate data using the recipes, and a schedule system generates schedule data using the recipes. However, this system and method is not particularly well suited for use in project home construction scenarios as mentioned above and is limited in its applicability to cost estimates and schedules.

In view of the above, it is desirable to provide methods and systems for the management of building construction projects, or similar projects, which more effectively handle customisations such as those discussed above for project home companies and the like. Furthermore, it is desirable to provide for greater integration of construction project management functionalities to allow improved efficiency and to reduce the likelihood of errors in the construction project and potentially costly rework.

### SUMMARY OF THE PRESENT INVENTION

In a first broad form the present invention seeks to provide a method for managing a construction project, wherein the method includes, in one or more electronic processing devices:
a) for a selected standard construction design, retrieving a construction model for the standard construction design from a store, the construction model including a plurality of material elements representing materials for use in carrying out a construction project in accordance with the construction model, each material element having material properties including construction attributes;
b) determining one or more design customisations;
c) updating the construction model in accordance with the one or more design customisations to thereby generate a customised construction model, by at least one of:
   i) adding one or more material elements;
   ii) removing one or more material elements; and,
   iii) modifying one or more material elements; and,
d) generating construction information associated with carrying out the construction project in accordance with the construction attributes of the customised construction model.

Typically the construction information includes at least one of:
a) a cost estimate for carrying out the construction project; and,
b) a schedule for carrying out the construction project.

Typically the construction information further includes at least one of:
a) a project duration;
b) a bill of materials;
c) a construction plan;
d) work instructions;
e) a contract clause;
f) a certification document; and,
g) a workplace health and safety document.

Typically the construction attributes include at least one of:
a) cost attributes; and,
b) scheduling attributes.

Typically the cost attributes include at least one of:
a) material costs;
b) delivery costs;
c) installation costs;
d) certification costs; and,
e) approval costs.

Typically the scheduling attributes include at least one of:
a) a task;
b) a link to another task;
c) a criticality indication;
d) a required resource.

Typically modifying a material element includes modifying a quantity of a respective material represented by the material element.

Typically the method includes determining the selected standard construction design by:
a) providing details of a plurality of available standard construction designs in the store; and,
b) obtaining a user selection of the selected standard construction design.

Typically the method further includes:
a) obtaining a user selection of a construction preference; and,
b) providing details of at least one of the available standard construction designs satisfying the construction preference.

Typically the method includes determining the design customisation by:
a) providing details of a plurality of available design customisation options for the selected standard construction design; and,
b) obtaining a user selection of the selected design customisation.

Typically the method includes:
a) determining a plurality of selected design customisations; and,
b) updating the construction model in accordance with the plurality of selected customisations.

Typically generating the construction information includes generating a cost estimate for carrying out the construction of project, the method including:
a) retrieving a template cost estimate for constructing the selected standard construction design; and,
b) generating the cost estimate by updating the template cost estimate in accordance with the one or more design customisations.

Typically the method includes, for each design customisation:
a) determining a cost variation associated with the design customisation; and,
b) updating the template cost estimate in accordance with the cost variation.

Typically generating the construction information includes generating a schedule for carrying out the construction project, the method including:
a) retrieving a template schedule for constructing the selected standard construction design; and,
b) generating the schedule by modifying the template schedule in accordance with the one or more design customisations.

Typically the method includes, for each design customisation:
a) determining a task associated with the design customisation; and,
b) modifying the template schedule to incorporate the task.

Typically the template schedule includes a plurality of standard tasks for the construction of the selected standard construction design, at least some of the standard tasks being linked to one or more other standard tasks, the method including modifying the template schedule by linking the task associated with the design customisation to one or more of the standard tasks.

Typically generating the construction information includes causing a plan for the construction to be generated, the method including:
a) retrieving a template plan for the construction of the selected standard construction design; and,
b) causing the plan to be generated by requesting that the template plan be updated in accordance with the one or more design customisations.

Typically the method includes, for each design customisation:
a) determining a plan change associated with the design customisation; and,
b) requesting that the plan be modified to incorporate the plan change.

Typically the method includes determining whether the plan change is in accordance with predetermined design parameters.

Typically the method includes, in the event a plan change is not in accordance with predetermined design parameters:
a) triggering a review of the plan change prior to requesting that the plan be modified;
b) modifying the plan change to satisfy the predetermined design parameters to thereby generate a modified plan change;
c) requesting that the plan be modified to incorporate the modified plan change; and,
d) checking the plan following modification to ensure the modified plan change is incorporated.

Typically the method includes generating a bill of materials in accordance with the plan.

Typically the material properties of at least some of the material elements of the construction model include a trigger for triggering, in response to an event, one or more actions during the construction project.

Typically the method includes:
a) receiving an event indication for an event that has occurred during the construction project; and,
b) determining one or more actions to be performed in response to the event in accordance with one or more triggers of the material elements of the construction model.

Typically the method includes providing an event processor agent for:
a) receiving the event indication for the event;
b) processing the event indication in accordance with predetermined processing rules to determine one or material elements including triggers for one or more actions in response to the event; and,
c) causing the action to be performed.

Typically the one or more actions include at least one of:
a) generating a task in the schedule;
b) generating a document;
c) modifying a document; and,
d) generating a notification.

Typically the document is one of:
a) a quality assurance document;
b) a safety plan document;
c) a certification document;
d) an inspection document; and,
e) a contract document.

Typically the method includes storing the document in a store.

Typically the method includes delivering the document to a recipient selected based on a type of the document.

Typically the document includes a barcode, the method including having a user scan the barcode to indicate compliance with the document.

Typically the method includes:
a) obtaining details of a scanned barcode; and,
b) generating an event indication corresponding to the compliance with the document.

Typically determining the one or more design customisations includes:
a) obtaining site details for a construction site for the construction project; and,
b) determining design customisations to allow construction project to be carried out on the construction site in accordance with the site details.

Typically the construction model includes a hierarchical arrangement of material elements.

Typically the construction model includes a plurality of sub-assemblies of material elements each representing a respective sub-assembly of materials for use in carrying out the construction project.

Typically at least one design customisation relates to a sub-assembly, such that updating the building model in accordance with the at least one design customisation includes at least one of:
a) adding one or more sub-assemblies of material elements;
b) removing one or more sub-assemblies of material elements; and,
c) modifying one or more sub-assemblies of material elements.

Typically the method includes generating the construction information using a server processing system and providing the construction information to a user using a client processing system.

Typically the method includes providing a web portal for allowing the user to interact with construction information relevant to the user.

Typically the construction project is for at least one of:
a) constructing a new building;
b) renovating of an existing building;
c) incorporating an improvement to an existing building;
d) constructing a pool; and,
e) constructing landscaping.

Typically the construction project includes work involving at least one of:
a) mechanical services;
b) electrical services;
c) plumbing;
d) roofing;
e) cabinet making;
f) air conditioning; and,
g) recladding.

In a second broad form the present invention seeks to provide apparatus for managing a construction project, wherein the apparatus includes one or more electronic processing devices that:
a) for a selected standard construction design, retrieves a construction model for the standard construction design from a store, the construction model including a plurality of material elements representing materials for use in carrying out a construction project in accordance with the construction model, each material element having material properties including construction attributes;
b) determines one or more design customisations;
c) updates the construction model in accordance with the one or more design customisations to thereby generate a customised construction model, by at least one of:
   i) adding one or more material elements;
   ii) removing one or more material elements; and,
   iii) modifying one or more material elements; and,
d) generates construction information associated with carrying out the construction project in accordance with the construction attributes of the customised construction model.

In a third broad form the present invention seeks to provide a method for managing a building construction project, wherein the method includes, in one or more electronic processing devices:
a) for a selected standard building design, retrieving a building model for the standard building design from a store, the building model including a plurality of material elements representing materials for use in constructing a building in accordance with the building model, each material element having material properties including construction attributes;
b) determining one or more design customisations;
c) updating the building model in accordance with the one or more design customisations to thereby generate a customised building model, by at least one of:
   i) adding one or more material elements;
   ii) removing one or more material elements; and,
   iii) modifying one or more material elements; and,
d) generating construction information associated with construction of the building in accordance with the construction attributes of the customised building model.

In a fourth broad form the present invention seeks to provide apparatus for managing a building construction project, wherein the apparatus includes one or more electronic processing devices that:
a) for a selected standard building design, retrieves a building model for the standard building design from a store, the building model including a plurality of material elements representing materials for use in constructing a building in accordance with the building model, each material element having material properties including construction attributes;
b) determines one or more design customisations;
c) updates the building model in accordance with the one or more design customisations to thereby generate a customised building model, by at least one of:
   i) adding one or more material elements;
   ii) removing one or more material elements; and,
   iii) modifying one or more material elements; and,
d) generates construction information associated with construction of the building in accordance with the construction attributes of the customised building model.

### BRIEF DESCRIPTION OF THE DRAWINGS

An example of the present invention will now be described with reference to the accompanying drawings, in which:—

FIG. 1 is a flow chart of an example of a method for managing a construction project;

FIG. 2 is a schematic diagram of an example of a distributed computer architecture;

FIG. 3 is a schematic diagram of an example of a server processing system;

FIG. 4 is a schematic diagram of an example of a client processing system;

FIG. 5 is a flow chart of an example of a method for selecting a standard building design and design customisations;

FIG. 6 is a flow chart of an example of a method for generating a cost estimate for a customised building design;

FIG. 7 is a flow chart of an example of a method for generating a schedule for a customised building design;

FIG. 8 is a flow chart of an example of a method for generating a plan for a customised building design;

FIG. 9 is a schematic diagram of a modular system for implementing a method for managing a building construction project;

FIG. 10 is a schematic diagram showing an example of a portion of a schedule;

FIG. 11 is a schematic diagram showing an example of an event processor agent;

FIG. 12 is a schematic diagram showing examples of trigger events and actions associated with material properties; and,

FIG. 13 is a schematic diagram showing example actions triggered by a Workplace Health & Safety Requirements material property.

### DETAILED DESCRIPTION OF THE PREFERRED EMBODIMENTS

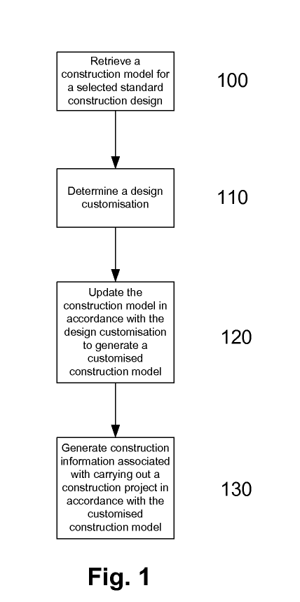

An example of a method for managing a construction project will now be described with reference to FIG. 1. It is noted that this example, and further detailed examples to follow, will be described with reference to a building construction project for constructing a residential project home, although it will be appreciated that the method may be applied to construction projects for a range of different building types and to a range of different types of construction projects as will be discussed in more detail below.

For the purpose of this example it is assumed that the method is performed at least in part using one or more electronic processing devices forming part of a processing system, which may be coupled to one or more other computer systems via a communications network architecture, as will be described in more detail below.

In step 100, a construction model is retrieved for a selected standard construction design, such as a standard design of a project home offered by a project home construction company. The construction model will typically be retrieved from a store, which may form part of the processing system along with the one or more electronic processing devices or may otherwise form part of another processing system which can be accessed via the aforementioned communications network.

The construction model includes a plurality of material elements representing materials for use in carrying out the construction project in accordance with the building model. In the context of the present example, the material elements may represent materials for constructing the project home. Each material element has material properties including construction attributes. Thus, the construction model provides a framework for capturing construction attributes for the construction project, which can be used for preparing construction information associated with carrying out the construction project.

One or more design customisations are determined in step 110. It will be appreciated that whilst a standard construction design for a project home or the like could be selected by a customer or other stakeholder without requiring any customisations, this is rarely the case, and usually the design will require at least some level of customisation, even if this is only at a relatively superficial level. Irrespective of the complexity of the design customisations required, these will need to be included in the preparation of the construction information, to ensure that all customisations will be accounted for throughout the construction process and, importantly, actually provided in the constructed building or any other form of construction as a result of carrying out the construction project.

With regard to building construction projects such as for project homes, it will be appreciated that design customisations may be determined as part of an initial sales estimating procedure where a customer will select their desired home design and then select from a range of options, although it should be noted that the design customisation in this example is not limited to selected options prior to construction and may also refer to any other design changes which may arise at any stage throughout a construction process. For example, the design customisation may include a design customisation required during construction, which may be requested by the customer or necessitated due to material unavailability, or the like. The design customisation may be selected from a plurality of design customisation options or alternatively may be defined manually, typically via user input using one or more of the electronic processing devices.

In step 120, the construction model is updated in accordance with the design customisations to thereby generate a customised construction model. This will generally involve changing the configuration of the material elements included in the construction model. Accordingly, the updates may be achieved by adding one or more material elements, removing one or more material elements, or modifying one or more material elements included in the construction model. Thus, the material elements in the customised construction model will reflect represent the materials for use in construction of a building or otherwise carrying out a construction project incorporating the design customisation determined at step 110. These updates to the construction model are preferably automated by the one or more electronic processing devices as much as possible for maximum efficiency.

Finally, step 130 involves generating construction information associated with carrying out the construction project in accordance with the construction attributes of the customised construction model. Typically the generation of the construction information will be automated by the one or more electronic processing devices. In some examples, the construction information can be generated by obtaining template construction information for the standard construction design, such as a standard building design for a project home or for any other construction component, and updating/modifying the template construction information in accordance with the design customisations. It will be appreciated that this approach will be particularly beneficial in the application of the method to the construction of project homes or similar projects where template construction information such as cost estimates, schedules or plans will be readily available for the standard building design. However, in alternative examples, the construction information can be newly generated based on the customised construction model.

It will be appreciated that this method allows for the convenient generation of a range of different construction information which will be tailored to reflect the design customisations. This is particularly facilitated by having the construction information generated in accordance with the construction attributes of the particular material elements in the customised construction model.

Accordingly, when a material element is added to the construction model this will introduce the need to incorporate additional materials in the construction process, and the construction attributes associated with the added material element will be accounted for in the generation of the construction information. Similarly, removal of a material element will mean that the construction attributes of the removed material element will no longer be accounted for in the generation of the construction information. In the case of modifying a material element, this may involve, for example, modifying a quantity of material represented by the material element as required for the construction project, or otherwise modifying other qualitative parameters such as colour, material type or the like. In any case the modifications may result in changes to the construction attributes and as such these changes will be reflected in the construction information when it is generated.

It will be understood that the above described method will be particularly useful in the operations of project home construction companies or other businesses facing similar problems as this can facilitate the efficient generation of a wide range of construction information for buildings that involve customisations from standard building designs, by providing a set of building model for the standard building designs and accounting for the customisations through updates to the building model.

Project home construction companies have traditionally needed to manually update construction information to reflect customisations and as such there have commonly been significant additional costs associated with customisations from the standard designs on offer. Furthermore, the conventional reliance on manual updates to construction information carries an increased risk of errors being introduced into the construction information which may result in construction being completed incorrectly, potentially requiring costly rework or inadvertent introduction of unsafe building practices. Whilst computer implemented techniques for managing construction projects have been widely adopted, these are generally ill equipped to handle updates across different forms of construction information and thus time-consuming manual updates are still required to accommodate design customisations.

In contrast, the above discussed techniques allow design customisations to be propagated throughout the construction information so that the different types of construction information that may be required at different stages throughout the construction process can be generated consistently with the customised building model. In addition, by carrying out the updates and generating the construction information using one or more electronic processing devices this helps to minimise the opportunities for errors/omissions. Moreover, the construction information can be prepared by a computer using the above described techniques far more rapidly than under conventional approaches, which can allow for a more streamlined construction process and lower costs.

The use of a construction model which can be updated in accordance with design customisations improves the operation of the computer, since this facilitates the efficient automatic generation of construction information that reflects the design customisations based on the customised construction model, which has not previously been achieved in an effective manner.

As mentioned above, whilst the above method can be particularly advantageous for project home construction projects, there are a wide range of other types of construction projects where the same principles can be usefully applied.

New building construction projects other than for residential project homes may still require customisations from standard designs. For example, standardised designs for commercial or industrial buildings, such as warehouses or the like, may need to be customised to accommodate particular site requirements or other customer preferences, in which case it will be understood that the above method will be beneficial.

Furthermore, the method may be applied to other construction projects that do not necessarily relate to the construction of a new building but still operate on similar processes. Renovation projects may be standardised and design customisations may be applied to adopt standard designs to an existing building structure. For example, standard kitchen or bathroom designs may be offered by a builder for renovating a customer's home, and the standard designs would usually be customised to accommodate the particular layout and structural features of the relevant part of the home. It will be understood that this can allow the builder to quickly sell such renovations from a standard design and conveniently adapt these as required for allowing successful installation. Similar advantages will be realised for standard home extensions and installations of other building improvements such as decks, patios, carports, lifts, air conditioning, plumbing, electrical and other services, or the like.

The above method may also be applicable to other non-building construction applications, such as for landscaping construction or pool construction projects. Construction projects may include work involving a range of different trades/services, such as mechanical services, electrical services, plumbing, roofing, cabinet making, air conditioning or recladding. It will thus be appreciated that the aforementioned principles have broad application to practically any construction project that requires customisations for adjusting a standard design to customer or site requirements and is sufficiently complex to justify at least some degree of project management and the generation of construction information associated with the construction process.

In particular embodiments of the above discussed method, the construction information may include at least a cost estimate for carrying out the construction project or a schedule for carrying out the construction project.

In the case where the construction information includes a cost estimate, it will be appreciated that the method can usefully streamline the preparation of cost estimates, such as during an initial sales estimating process where a customer is seeking preliminary cost estimates for the construction of a customised version of a standard design, and also during a final estimating process where a final cost estimate is used to determine total contracted costs and payments for construction.

In the case where the construction information includes a schedule, it will be appreciated that the method can conveniently allow a schedule to be prepared for a customised construction project based on the customised construction model, so as to account for tasks associated with carrying out the construction project using each of the materials represented by the building elements. When the construction model is updated to add/remove/modify material elements, this will have a resulting impact on the schedule. For example, updates to the construction model may result in modifications to a critical path of the project schedule, such as by altering the required order of tasks or the timing of tasks on the critical path, which could have a knock-on effect of reducing or increasing the total project duration. These and other types of impacts on the schedule can be more readily accounted for using the above mentioned method.

It should be noted that the construction information need not be limited to a cost estimate or a schedule, although these are two key pieces of construction information that will generally be required as part of the majority of construction projects and for which the streamlined generation thereof will be useful, such as for constructing project homes and other types of construction projects as discussed above.

Nevertheless, it will be appreciated that other types of construction information may also be generated using the above method, including a project duration, a bill of materials, a construction plan, work instructions, a workplace health and safety document, a certification document, contract clauses, or the like. Whilst the detailed examples below may not explicitly provide each of the aforementioned types of construction information, it will be understood that similar processes will apply to allow a range of different types of construction information.

In order to generate cost estimates using the above discussed method, the construction attributes for each material element will generally include cost attributes, which relate to the costs associated with incorporating the material represented by the material element into the construction process. A range of different cost attributes may be provided for a material element, depending on the type of material represented by the material element and the corresponding costs that may be incurred when using the material in carrying out the construction project, such as when installing a material as part of constructing a building.

For example, the cost attributes may include material costs, delivery costs, installation costs, certification costs, or approval costs, although it will be appreciated that this list is not exhaustive. Material costs may relate to costs for obtaining the material (or one or more required components of the material). Delivery costs may relate to costs associated with the delivery of the material from a supplier and/or to a construction site. Installation costs may relate to labour costs that will be incurred by a tradesperson, subcontractor or the like to actually install the material during construction. There may be different installation cost components for different trades or for work required to complete the installation of the material at different stages of construction. Certification costs may relate to costs associated with obtaining certification that the material has been properly incorporated as part of the construction process, and may involve costs associated with having safety inspections performed. Approval costs may be required, for instance, if government approval is required for an aspect of construction associated with the material.

On the other hand, in order to generate construction information including a schedule, the construction attributes will typically include scheduling attributes, which may relate to different impacts on the schedule due to the incorporation of the material into the construction of the building or other construction project. It will be appreciated that by providing suitable scheduling attributes in the material properties for each material element used in the construction model, the schedule can be generated to account for the schedule impacts. Under conventional techniques, this has required substantial manual effort due to the need to review construction documentation and ensure the project schedule is prepared appropriately to accommodate all tasks that may be required. Under the methods described herein, this manual effort can be reduced or eliminated by having the construction model capture the scheduling attributes so that the schedule can be generated in accordance with the scheduling attributes.

The scheduling attributes may include, for instance, a task (such as an additional task associated with the material element), a link (such as to another known task that will be performed in carrying out the construction project), a task order, a criticality indication (i.e. indicating whether the installation of the material is on a critical path for the project, or a required resource (such as a tradesperson, subcontractor or the like) which should be scheduled to allow the material to be installed.

In any event, it will be understood that the above method, as exemplified for allowing the generation of construction information in the form of a cost estimate or schedule for a building construction project or the like, will provide a convenient means for facilitating the management of a construction process. As will be discussed below with regard to more detailed examples, the method can be extended to streamline a range of different aspects of the construction process and furthermore to reduce costs and avoid rework which may otherwise be involved due to the large amount of manual effort (and resultingly high risk of manually introduced errors) typically called upon in conventional management techniques.

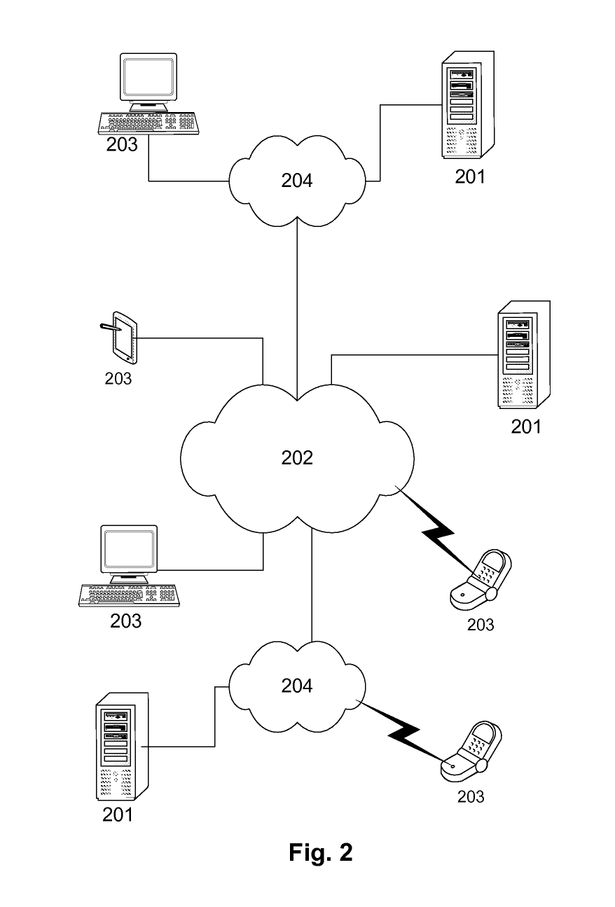

In one example, the method is performed by one or more processing systems operating as part of a distributed architecture, an example of which will now be described with reference to FIG. 2.

In this example, the arrangement includes a number of processing systems 201, 203 interconnected via one or more communications networks, such as the Internet 202, and/or a number of local area networks (LANs) 204. It will be appreciated that the configuration of the networks 202, 204 are for the purpose of example only, and in practice the processing systems 201, 203 can communicate via any appropriate mechanism, such as via wired or wireless connections, including, but not limited to mobile networks, private networks, such as an 802.11 networks, the Internet, LANs, WANs, or the like, as well as via direct or point-to-point connections, such as Bluetooth, or the like.

The nature of the processing systems 201, 203 and their functionality will vary depending on their particular requirements. In one particular example, the processing systems 201, 203 represent servers and clients, although this is not essential and is used primarily for the purpose of illustration.

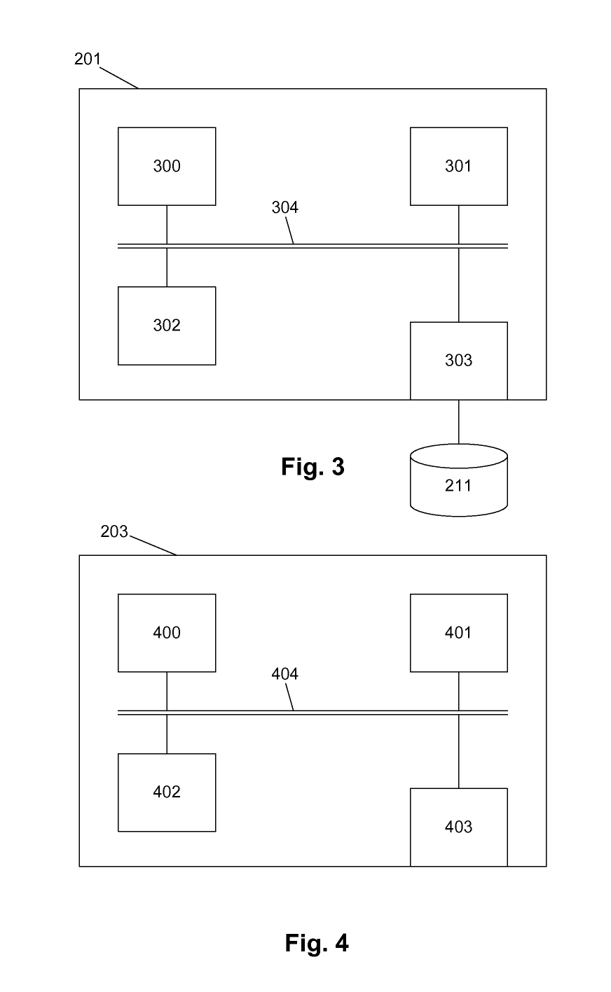

An example of a suitable processing system 201 is shown in FIG. 3. In this example, the processing system 201 includes an electronic processing device, such as at least one microprocessor 300, a memory 301, an optional input/output device 302, such as a keyboard and/or display, and an external interface 303, interconnected via a bus 304 as shown. In this example the external interface 303 can be utilised for connecting the processing system 201 to peripheral devices, such as the communications networks 202, 204, databases 211, other storage devices, or the like. Although a single external interface 303 is shown, this is for the purpose of example only, and in practice multiple interfaces using various methods (e.g. Ethernet, serial, USB, wireless or the like) may be provided.

In use, the microprocessor 300 executes instructions in the form of applications software stored in the memory 301 to perform required processes, such as communicating with other processing systems 201, 203. Thus, actions performed by a processing system 201 are performed by the processor 300 in accordance with instructions stored as applications software in the memory 301 and/or input commands received via the I/O device 302, or commands received from other processing systems 201, 203. The applications software may include one or more software modules, and may be executed in a suitable execution environment, such as an operating system environment, or the like.

Accordingly, it will be appreciated that the processing systems 201 may be formed from any suitable processing system, such as a suitably programmed computer system, PC, web server, network server, or the like. In one particular example, the processing system 201 is a standard processing system such as an Intel or AMD Architecture based processing system, which executes software applications stored on non-volatile (e.g., hard disk) storage, although this is not essential. However, it will also be understood that the processing systems 201 could be or could include any electronic processing device such as a microprocessor, microchip processor, logic gate configuration, firmware optionally associated with implementing logic such as an FPGA (Field Programmable Gate Array), or any other electronic device, system or arrangement.

As shown in FIG. 4, in one example, the processing systems 203 include an electronic processing device, such as at least one microprocessor 400, a memory 401, an input/output device 402, such as a keyboard and/or display, and an external interface 403, interconnected via a bus 404 as shown. In this example the external interface 403 can be utilised for connecting the processing system 203 to peripheral devices, such as the communications networks 202, 204, databases, other storage devices, or the like. Although a single external interface 403 is shown, this is for the purpose of example only, and in practice multiple interfaces using various methods (e.g. Ethernet, serial, USB, wireless or the like) may be provided.

In use, the microprocessor 400 executes instructions in the form of applications software stored in the memory 401 to perform required processes, for example to allow communication with other processing systems 201, 203. Thus, actions performed by a processing system 203 are performed by the processor 401 in accordance with instructions stored as applications software in the memory 402 and/or input commands received from a user via the I/O device 403. The applications software may include one or more software modules, and may be executed in a suitable execution environment, such as an operating system environment, or the like.

Accordingly, it will be appreciated that the processing systems 203 may be formed from any suitable processing system, such as a suitably programmed PC, Internet terminal, lap-top, hand-held PC, smart phone, PDA, tablet, or the like. Thus, in one example, the processing system 203 is a standard processing system such as an Intel or AMD Architecture based processing system, which executes software applications stored on non-volatile (e.g., hard disk) storage, although this is not essential. However, it will also be understood that the processing systems 203 can be any electronic processing device such as a microprocessor, microchip processor, logic gate configuration, firmware optionally associated with implementing logic such as an FPGA (Field Programmable Gate Array), or any other electronic device, system or arrangement.

It will also be noted that whilst the processing systems 201, 203 are shown as single entities, it will be appreciated that this is not essential, and instead one or more of the processing systems 201, 203 can be distributed over geographically separate locations, for example by using processing systems provided as part of a cloud based environment.

Examples of the above described method(s) will now be described in further detail. For the purpose of these examples, it is assumed that the method is conducted using at least a server processing system 201, the database 211 being used to store available construction models for retrieval, and also to store customised construction models as these are generated. Generated construction information will typically also be centrally stored and managed using the database 211. Furthermore, the server processing system 201 may handle other processing activities associated with the construction model throughout the construction process, examples of which will be described below.

Interactions by a user as required in the selection of a standard construction design, the determination of design customisations, and other user inputs as will be exemplified further below, may be via the server processing system 201 in some examples. However, more typically, at least some of the user interactions will be via a client processing system 203. Different users may have their own client processing systems 203 for interacting with the server processing system 210. For instance, potential customers may interact with their own client processing system 203 in selecting a standard construction design and desired design customisations through a customer-facing web interface, and sales estimating staff may interact with different client processing systems 203 through a more advanced interface allowing deeper customisations and selections of options not available to the customer. Other users may include draftspersons, subcontractors, construction supervisors and the like, and their interfaces may be tailored accordingly.

It will also be assumed that the user interacts with the server processing system 201 via a GUI (Graphical User Interface), or the like, presented on the client processing system 203, and in one particular example via a browser application that displays web pages hosted by the server processing system 201.

For the purpose of this example, it is assumed that the server processing system 201 hosts web pages for providing portals for different user interactions as needed in the method via their respective client processing systems 203. These portals may be tailored depending on the interaction needs of the user and the types of information these users may be granted access to, for instance.

However, in other examples, the server processing system 201 may communicate with application software executed on the client processing system 203 for allowing the required user interactions. Different versions of the application software may be provided to suit different user requirements, or, alternatively, the same version may be provided but specific functionality offered by the application may be restricted depending on the type of user or whether the user has authorisation to access particular functionalities.

In some examples, at least some of the client processing systems 203 may be conveniently provided in the form of a mobile device such as a smart phone, tablet or the like to allow user interactions from a range of different locations aside from those provided with fixed computing infrastructure. For example, user interactions may take place at a construction site, a display home or a customer's residence, to facilitate improved flexibility over where steps of the method can carried out. It will be appreciated that the interactions with the server processing system 203 in this example can be via a software application program suitably configured for execution on the mobile device and allowing communication via a communications network to which the mobile device is connected.

It will also be understood that client processing systems 203 in the form of mobile devices may use mobile communications technologies such as Short Message Service (SMS) to facilitate required communications during the construction process, where appropriate. For instance, SMS messages may be send to a subcontractor's smart phone to remind the subcontractor of an upcoming event or task, or to otherwise trigger an action.

However, it will be appreciated that the above described configuration assumed for the purpose of the following examples is not essential, and numerous other configurations may be used. It will also be appreciated that the partitioning of functionality between the processing systems 201, 203 may vary, depending on the particular implementation.

The detailed examples to follow are provided to explain further preferred aspects of the above described method and optional features with regard to preferred implementations of the method and other related methods. It is noted these examples are described in the context of building projects for the sake of allowing further specific details to be provided for a practical implementation of the method. Nevertheless, it will be understood in view of the discussions above that similar principles will also apply to a broad range of other types of construction projects. As such, it will be appreciated that references to a “building design”, a “building model” or other related terms with regard to the construction of a building in the following examples can be considered to more generally relate to equivalent terms in relation to carrying out other types of construction projects, such as a “construction design” or a “construction model”.

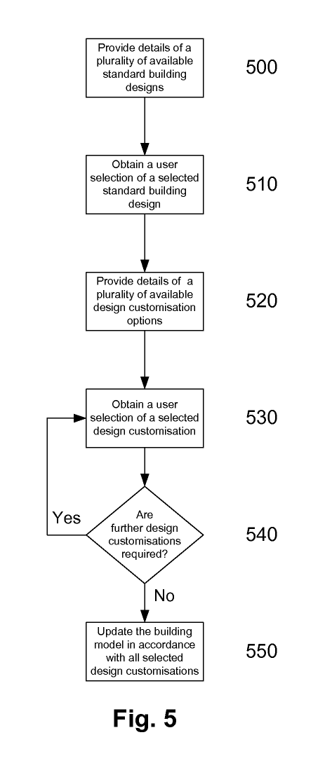

In any event, an example of a method for selecting a standard building design and design customisations will now be described with reference to FIG. 5.

In step 500, details of a plurality of available standard building designs in the store are provided, typically by displaying the details on a display of a client processing systems 203. It will be appreciated that as part of this process, the server processing system 201 may access available building designs stored in the database 211, and then provide an indication of these to the user, for example by displaying a webpage including a list of available building designs. The particular client processing system 203 may depend, for example, on the user, i.e. the user may be a customer or a staff member assisting the customer through a sales estimating process.

In any case, in step 510 a user selection of the selected standard building design will be obtained. Typically, this will involve the user inputting the user selection via a user interface of the respective client processing system 203, for example by selecting one of the building designs on the list.

The server processing system 201 may be adapted to search for relevant designs based upon criteria entered by a user, such as keywords, selection of building categories, or the like. For example, the number of available standard building designs may be greater than the amount of building designs that can conveniently have details provided to the user. Accordingly, it may be desirable to allow user filtering of the available standard building designs. In this case the method may further include obtaining a user selection of a building preference and then providing details of at least one of the available standard building designs satisfying the building preference. In this way, a filtered sub-set of the available standard building designs can be provided which are more likely to be relevant to the user's interest. The building preferences may include parameters such as the number of rooms, floor size ranges, number of floors, or the like, and numerous other useful building preferences will be apparent to those skilled in the art.

In step 520, details of a plurality of available customisation options are provided. Typically, a standard building design such as for a project home will be configured to accommodate a range of optional variations, which can be included in the design according to customer preferences. For instance, customisation options may include material types/colours used to construct the building, and these may be organised such as based on external/internal options, superficial/structural options or the like to assist user navigation of the options. The customisation options may relate to a single material used in the construction of the building (such as roof tiles), equipment to be installed (such as an air conditioning system) or may relate to an options with a building-wide effect (such as an increased ceiling height) or the addition of an entire sub-assembly to the building (such as a patio structure).

In any event, the next step, at step 530, is to obtain a user selection of a selected design customisation. Once again, the available customisation options may be filtered according to user preferences, as discussed above for available standard building designs.

Often, multiple design customisations will be required by a customer and these can be selected sequentially by checking, at step 540, whether further customisations are required, and if so, obtaining the next user selection of a design customisation. In this regard, it will also be appreciated that some customisations may be interdependent, so that for example it is not possible to select a patio paving type until a patio has been included in the design. Accordingly, this process allows customisations to be introduced progressively, enhancing the degree of flexibility, whilst providing a straightforward mechanism for adding customisations.

Once all required design customisations have been selected, the building model can then be updated in accordance with all of the selected design customisations, as per step 550, with the updated model typically being stored in the database 211 for subsequent use.

As discussed above, this will typically involved adding/removing/modifying material elements within the building model. Some design customisations will have a direct one-to-one relationship with material elements used in the building model. For instance, a design customisation involving changing the colour of roof tiles will be accounted for by modifying the material properties of the roof tile material elements in the building model. However, other design customisations may have wider reaching impacts on the material elements. For instance, adding an optional fireplace may involve adding material elements used to construct the fireplace and removing other material elements which would otherwise be used to construct a portion of the wall where the fireplace is to be installed. In some embodiments, the available customisation options may be configured to account for these types of impacts by replacing entire sub-assemblies within the building model as required.

Accordingly, in one example, the material elements of the building model may be organised in a hierarchical arrangement representing the assembly of materials in the construction of the building, and may define sub-assemblies of materials such that design customisations may include adding/removing or modifying sub-assemblies to thereby modify more than one material element at the same time.

Whilst the above method has been described with regard to user selected design customisations, it will be appreciated that other types of design customisations may be necessitated due to the site for constructing the building, or pre-existing works on the site. Thus, in another example, determining the design customisations may involve obtaining site details for a construction site for constructing the building and determining design customisations to allow the building to be constructed on the construction site in accordance with the site details. In any case, the design customisations can be incorporated by updates to the building model in a similar fashion as per the user selected design customisations discussed above.

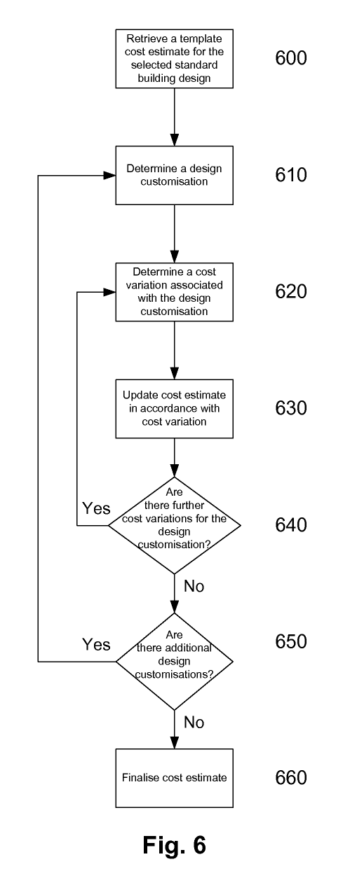

An example of a method for generating a cost estimate for a customised building design will now be described with reference to FIG. 6.

In general terms, this example relates to a case where generating the construction information includes generating a cost estimate for the construction of the building, particularly involving retrieving a template cost estimate for the selected standard building design and generating the cost estimate by updating the template cost estimate in accordance with the one or more design customisations. These updates may be performed iteratively for each design customisation by determining a cost variation associated with the design customisation and updating the template cost estimate in accordance with the cost variation.

In this particular example, at step 600, a template cost estimate is retrieved for the selected standard building design. The template cost estimate may be stored, for example, in the database 211 of the server processing system 201, and may be associated with details of the standard building design and/or the corresponding building model. The template cost estimate may have been manually generated for the standard building design or alternatively, it may have been previously automatically generated using the building model for the standard building design and stored for later use. In either case, the template cost estimate will usually have been validated to ensure the template cost estimate has good correlation with the expected costs associated with constructing the standard building design without any design customisations.

In step 610, a design customisation is determined, such as by determining the first design customisation in a list of multiple design customisations selected by the user as per the example method described above with reference to FIG. 5. In some examples, pre-existing design customisations may be stored, and these can be selected, retrieved and subsequently used as a basis for a new design customisation.

Having determined the design customisation, a cost variation associated with the design customisation is determined at step 620. The cost variation will typically be determined based on material properties of the material elements involved in the design customisation. In particular, the material properties will include cost attributes as discussed above, and these cost attributes can be used to calculate the cost of installing each material element as part of construction of the building. In the case of a design customisation involving the addition or removal of one or more material elements, the associated cost variation will be directly based on the cost of the material elements. Where the design customisation involves modifying material elements, this may still have an impact on the cost and the cost variation may be determined by recalculating the cost for the modified material elements and comparing this to the original cost.

In any case, in step 630 the cost estimate will be updated in accordance with the cost variation for the particular design customisation under consideration. Depending on the design customisation (i.e. whether this involves adding, removing, or modifying material elements), the update may involve adding new costs to, removing existing costs from, or replacing costs in the template estimate as required. The resulting updated version of the estimate will thus reflect the costs involved for incorporating the design customisation, whether this increases or decreases the total cost.

In the event it is determined that there are further cost variations for the design customisation at step 640, steps 620 and 630 will be repeated to determine another cost variation associated with the design customisation and update the cost estimate accordingly.

Once all cost variations for the particular design customisation have been considered, it will be determined whether additional design customisations need to be considered at step 650. If so, the method will repeat steps 610 to 640 as required for the next design customisation.

Finally, when the estimate has been updated in accordance with all of the cost variations, for all of the design customisations, the estimate can be finalised at step 660 and then stored in the database 211, for example as part of the building model. The finalisation of the estimate may also include updating costs for material elements already included in the estimate from the template estimate, to ensure these reflect the most current cost information available from suppliers, subcontractors or the like.

It will be appreciated that the above process for generating the estimate allows the predetermined template estimate to be leveraged so that a new estimate can be rapidly and reliably calculated by mainly considering the design customisations from the standard building design for which the template estimate was prepared. By considering cost variations associated with each design customisation, this also allows for greater transparency of costs associated with design customisations, which will be of great value to cost sensitive customers.

In some implementations, the estimating process can be conducted in near real-time during a sales estimate meeting with a customer, and can be repeated for different design customisations to allow the customer to gain a better understanding of the cost impacts of their decisions regarding design customisations.

It will be understood that the estimating process above can also take better account of the cost variations associated with design customisations compared to traditional techniques which merely use set costs for typical design customisation options which may not reflect the actual costs considering knock-on effects and coupling with other aspects of the building construction process.

It should be appreciated that, in alternative embodiments, the cost estimate may be generated solely based on the cost attributes of the material elements without requiring the use of a template estimate. In this case, predetermined rules will be used to step through the material elements in the customised building model and determine associated costs for incorporating each material element in the construction process, such as by calculating costs based on material properties reflecting such cost attributes as unit costs and labour costs to build up a total estimate. However, this will not provide the advantages of transparency of the cost variations to the customer and may involve additional processing since this will not leverage an existing template estimate that has already been prepared for the standard building design.

Similar techniques as discussed above may also be applied to generating a schedule for the customised building design. Typically, the schedule will be generated following the customer's agreement on the customised building design, usually during or after the generation of the estimate as discussed above. There may also be further refinement of the estimate following the sales estimating process to ensure any required updates to the building plan following review by a draftsperson can be incorporated so that the estimate and the building model reflect the final version of the customised building design that will be constructed. As a result of generating the schedule, all required tasks for constructing the building in accordance with the customised design will be scheduled in a suitable order to allow the tasks to be performed in view of any task dependencies between tasks, such that an overall project duration and thus a completion date for the project can be established.

In general terms, the method of generating a schedule for a customised building design includes retrieving a template schedule for the construction of the selected standard building design and generating the schedule by modifying the template schedule in accordance with the one or more design customisations. In particular this may include, for each design customisation, determining a task associated with the design customisation and modifying the template schedule to incorporate the task. The template schedule may include a plurality of standard tasks for the construction of the selected standard building design, with at least some of the standard tasks being linked to one or more other standard tasks. Thus, the method may include modifying the template schedule by linking the task to one or more of the standard tasks.

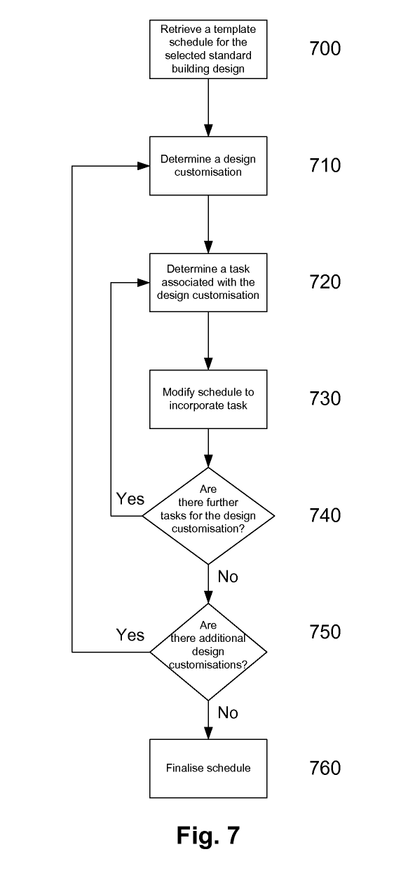

An example of such a method of generating a schedule will now be described with reference to FIG. 7.

In step 700, a template schedule is retrieved for the selected standard building design. As per the template estimate that was used in the estimating process discussed above, the template schedule may be stored in the database 211 of the server processing system 201, and may be associated with details of the standard building design and/or the corresponding building model. Typically the template estimate will include a plurality of standard tasks which provides the project framework and reflects the standard activities in the construction project. In addition, the template estimate will include tasks associated with the material elements included in the building model for the standard building design. These tasks may be provided as sub-tasks linked to the standard tasks.

In any event, following retrieval of the template schedule, an iterative process may be undertaken to modify the schedule in accordance with the design customisations. It will be noted that the following steps are similar to those taken in the generation of the estimate as discussed above, which reflects the fact that the schedule is generated using schedule attributes in the material properties of the material elements in a similar fashion to the generation of the estimate using cost attributes. However, the practical implementation varies slightly due to the differences in the nature of project schedules compared to cost estimates.

In step 710, a design customisation is determined. This design customisation will typically involve changes to the material elements in the customised building model compared to the standard building model selected by the customer. At least some of the material elements will have material properties which include schedule attributes, relating to how the incorporation of those material elements into a building will need to be accommodated in the schedule. For example, the schedule attributes may include information regarding associated sub-tasks, including their linkages to standard tasks in the template schedule and other scheduling information such as duration, required resources and the like.

Step 720 involves determining a task associated with the design customisation. This will typically involve determining one of the associated sub-tasks as discussed above. The information regarding this associated sub-task is then used to modify the schedule to incorporated the task in accordance with the design customisation, as per step 730. This will be a relatively straightforward matter when the design customisation includes the addition of a material element with an associated sub-task, as the modification of the schedule will simply involve adding the sub-task into the schedule with appropriate linkages to other standard tasks in the template schedule. On the other hand, a design customisation including the removal of a material element may require deleting an associated sub-task from the template schedule and ensuring any dependencies from that sub-task are corrected. It will also be appreciated that as part of this process, an assessment of task order may be required, to ensure that tasks are added in accordance with any order requirements.

In some examples, modifications to the schedule may involve modifying the tasks to be performed. In other examples, the schedule modifications may account for more complex scheduling aspects, such as the inclusion of one or more additional tasks in connection with work to be performed by other trades unrelated to the trade primarily responsible for performing work in relation to the particular material element. For example, a design modification relating to air conditioning installation may result in additional and/or modified tasks to be performed by an electrical tradesperson in view of changes to electrical specification for the building, but may also require a task to be performed by an engineer to redesign structural elements of the building in the vicinity of the air conditioning equipment, which may in turn affect tasks to be performed by other workers such as blocklayers or concreters. It will therefore be appreciated that all tasks associated with a material element addition/removal/change should be accounted for when the schedule is modified in accordance with a design customisation.

If it is determined at step 740 that there are further tasks for the design customisation, the method returns to step 720 where the next associated task will be determined and the schedule modified accordingly at step 730.

Once all associated tasks for the design customisation under consideration have been incorporated through appropriate modifications of the schedule, the method will then involve determining whether there are any additional design customisations to be considered in the schedule at step 750. If this is the case, steps 710 to 740 will then repeat as required to modify the schedule to incorporate any tasks associated with the next design customisation.

When it is determined at step 750 that all design customisations have been considered after the required iterations of the preceding steps, the schedule can then be finalised and stored at step 760. Although the generation of the schedule can be completely automated based on standard rules for incorporating tasks associated with material elements having schedule attributes, the finalisation of the schedule may involve a manual review of the generated schedule to ensure all tasks and linkages are correct.

In any case, it will be understood that generating a schedule based on a template schedule will greatly streamline the scheduling process for a building construction project for project homes or other types of buildings having a relatively high degree of design standardisation yet involving at least some design customisations from the standard design. This process removes the need for preparing a complete schedule from scratch and also allows automation of the process of modifying the schedule to reflect the design customisations.

Furthermore, by utilising schedule attributes in the material properties of each material element in the building model to modify the schedule, this can help to ensure that all tasks required for incorporating the material elements or a customised building models will be reflected in the final schedule. Thus this can help to avoid circumstances where the schedule inadvertently omits required tasks for incorporating materials, which can easily occur in conventional techniques using manually prepared schedules.

It will also be noted that the tasks associated with the material elements will not necessarily only involve installation/construction tasks but may also include tasks for required inspections and checks, which may be included as critical milestone tasks in the schedule. The automatic introduction of such inspections and checks can help to prevent the undesirable outcome of construction proceeding without a required inspection/check which can result in wasted time and/or costly rework in the event the inspection/check is ultimately performed and identifies flaws requiring correction.

Tasks may also be introduced to account for manufacturer lead times for deliveries of materials required for subsequent installation tasks. For example, if specific lead times are known for a particular component manufacturer, a task may be added to place the order with that manufacturer at a time that is sufficiently in advance of the requirement for the material so that the material can be delivered in time. Similarly, tasks may be introduced to allow pre-emptive notifications/reminders so that suppliers can ensure sufficient stock is available at a later required date, or to otherwise ensure any resources can be deployed as required to allow the project to be implemented smoothly.

Similar techniques as described above can also be utilised in the generation of other types of construction information in addition to cost estimates and schedules for customised building designs. For instance, another critical form of construction information is the building plan, which sets out details of the physical construction of the building. For the purpose of this description, the building plan refers to drawings which specify the physical configuration of the building including the layout of structural material elements such as walls, floors, roofing and the like and the location of installed material elements such as fittings for the kitchen, bathrooms, toilets and any other required equipment.

It will be understood that this is different to the building model which contains information regarding the building design in terms of material elements and their respective material properties, but does not necessarily provide this in a form that is readily understandable by subcontractors or tradespersons responsible for the actual construction/installation of the corresponding materials. Thus, the building plan may be generated based on the building model and exist alongside the building model as a particular embodiment of the information contained within the building model.

Conventional techniques for providing a building plan will usually involve having a draftsperson manually preparing the plan, typically using Computer Aided Design (CAD) software. The draftsperson will be responsible for ensuring the plan accurately reflects the configuration of the building to be constructed, and this can be come increasingly difficult and complicated in the event of significant design changes. In contrast, by using the building model and associated techniques discussed above, a plan may be tested to help to ensure the plan reflects all of the building customisations desired by the user and to also help to ensure conformance between the plan, the associated bill of materials, the estimate and schedule.

In general terms, a method for generating construction information in the form of a plan for the construction of the building will include retrieving a template plan for the construction of the selected standard building design and causing the plan to be generated by requesting that the template plan be updated in accordance with the one or more design customisations. This may be performed using an iterative process, which involves, for each design customisation, determining a plan change associated with the design customisation and requesting modifications to the plan to incorporate the plan change.

In some implementations, the method may include determining whether the determined plan change is in accordance with predetermined design parameters. In the event a plan change is not in accordance with predetermined design parameters, this may trigger a review of the plan change, after which the plan change can be modified to satisfy the predetermined design parameters to thereby generate a modified plan change and the plan can then be modified to incorporate the modified plan change.

As mentioned above, a building plan will commonly be associated with a bill of materials, and therefore the method of generating the plan may also include generating the bill of materials in accordance with the plan. This bill of materials will be different to the customised building model, being a list of all of the materials appearing plan itself and thus providing details of types and quantities of all materials to be sourced for constructing the building, but the materials listed should nevertheless correspond to the material elements in the customised building model, particularly in view of the fact that the plan was generated based on the customised building model.

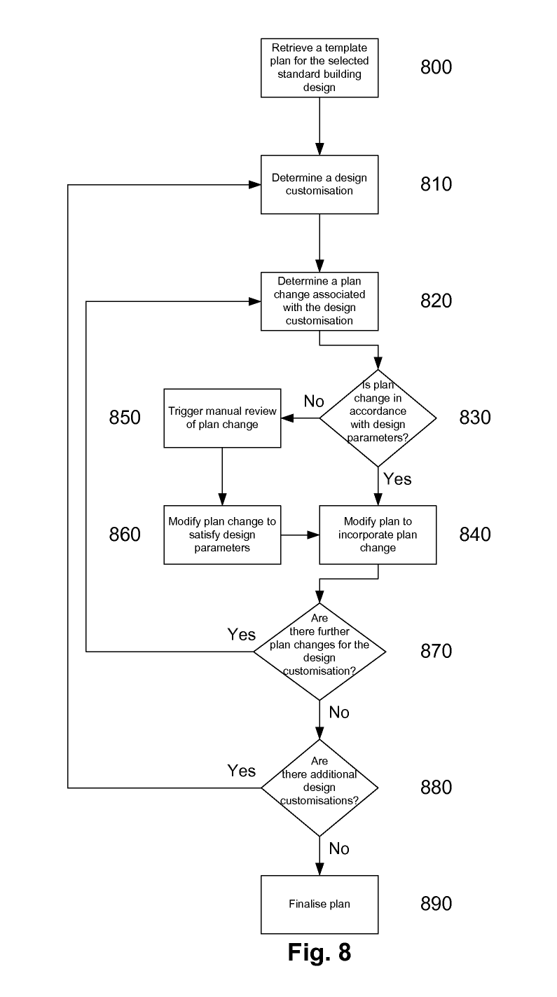

In view of the above, an example of a method for causing a plan for the customised building design to be generated will now be described with reference to FIG. 8.

In step 800, a template plan is retrieved for the selected standard building design. As per previous examples of generating other types of construction information, the template plan may be stored in the database 211 of the server processing system 201, associated with the building model for the standard building design. In the context of project home construction, it will be appreciated that standard plans will typically be available and these can be used as the template plan.

The template plan will typically have all configuration/layout details for allowing construction of the standard building design. Even in the unusual event of a customer opting to construct a building totally in accordance with the standard building design, modifications will typically still be required to ensure the design is suitable for the specific construction site. For example, slab design customisations may be needed to account for particular foundation properties such as the foundation materials on the site or other site conditions such as the presence of ground water. It is noted that similar considerations may affect a range of other services, whether these may be dependent on the construction site or on other existing constructions on the site. For instance, an installation of new structure and/or equipment into an existing structure, such as for a renovation project, will typically require modifications from a standard design to account for unique features of the existing structure into which the installation is to take place. In any event, most building construction projects will also typically involve at least some customer driven design customisations which will usually in turn result in the need for further modifications to the plan.

Having retrieved the template plan, a design customisation is determined at step 810, and following this, a plan change associated with the design customisation will be determined at step 820. The plan change will depend on the nature of the design customisation, such as whether this involves the addition or removal of material elements in the customised building model and in turn will require materials to be added or removed from the plan, or material quantities increased or reduced from the plan.

In some cases, the plan change may be complicated through the need to account for knock-on effects due to adding/removing/changing a material. For example, removing a window will require wall construction materials to added to fill the resulting void. These effects may not be automatically accounted for in the updates and may require manual intervention, however many of these types of knock-on effects can be handled through suitably configured rules for determining the plan changes.

On a related note, it will be appreciated that the implementation of the project in accordance with such plan changes may require different trades than may have been required for the template plan. For example, significantly increasing the size of a window may have substantial knock-on effects, such as requiring extensive structural design changes and the need for additional tradespersons such as steelworkers, crane operators or the like during construction. However, this may not be readily apparent to a customer or salesperson when the design customisation regarding the window is being determined, and may not be automatically accounted for in the material properties of the window.

Accordingly, in step 830, the plan change may be checked to determine whether this is in accordance with predetermined design parameters. Typically, this will involve the use of standard checking rules which have been established for different types of plan changes. In the event the plan change is found to be in accordance with the design parameters, then the method proceeds directly to step 840 where the plan is modified to incorporate the plan change. The modification of the plan may be accomplished by having the system request that the template plan be modified to incorporate the plan change. This request may be passed on to a draftsperson to allow the modifications using CAD software or the like.

However, if the check at step 830 determines that a plan change is not in accordance with the design parameters, then this may trigger a review of the plan change at step 850, prior to requesting that the plan be modified. This may involve having the draftsperson receiving an automatically generated indication of one or more reasons why the plan change was not in accordance with the design parameters to allow the draftsperson to consider the plan change in the context of the modified plan at that point in time. At step 860, the plan change may be modified to satisfy the design parameters, such as by having the draftsperson input an alternative plan change. The plan change can then be incorporated by modifying the plan at step 840.

If further plan changes are found to be required for the design customisation at step 870, then the method returns to step 820 for the next iteration of determining another plan change for the design customisation and requesting modifications to the plan to incorporate this.

Once all plan changes for the particular design change under consideration have been incorporated into the plan, the method will involve determining whether additional design customisations need to be considered at step 880, and if this is the case steps 810 to 870 will be repeated as required until all design customisations and their associated plan changes have been incorporated into the plan. Once this has occurred, the plan can then be finalised and stored for subsequent use, at step 890. The finalisation of the plan may involve checking the plan following modification to ensure the modified plan changes are incorporated and/or a final manual review of the plan by a draftsperson to ensure the final plan is of suitable quality. A bill of materials corresponding to the final plan may also be generated at this stage.

The final plan and/or the bill of materials may also be compared to the customised building model at this stage to ensure these conform to one another such that no design customisations or associated material elements are omitted from the final plan.

It will be appreciated that the above techniques for generating the plan may be facilitated by integrating software provided for carrying out the method with CAD software for actually preparing the building plan.

Whilst examples have been discussed above for generating key forms of construction information such as a cost estimate, a schedule and a plan for the construction of the customised building, it should be appreciated that a range of other types of construction information can be generated using similar techniques. Later examples will exemplify the generation of other types of construction information, although it is noted that the construction information discussed herein are not intended to be exhaustive.

The methods described above may be implemented using any suitable processing system arrangement, although as mentioned this will generally involve the use of at least a server processing system 201 and one or more client processing systems 203 for allowing users to access functionalities as required. In one example, the methods may be implemented using a modular system in which a plurality of different modules are provided for handling different functionalities. At least some of these modules may be provided as software modules.

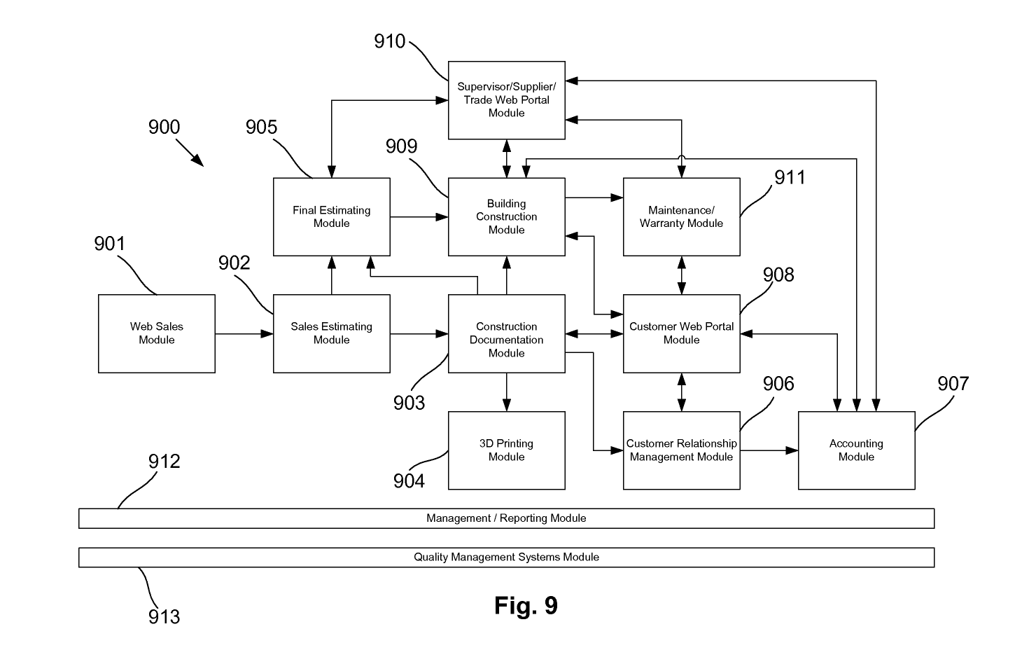

An example of such a modular construction management system 900 for implementing methods as discussed above will now be described with reference to FIG. 9. In this example, the system 900 is particularly configured to use with building construction projects, such as for constructing project homes, but as discussed above for the example processes described with reference to FIGS. 5 to 8, it will be understood that features of the example system 900 will also be applicable to other types of construction projects.

As shown, the system 900 is formed as an integrated system including a number of modules having interfaces therebetween. As indicated, the interfaces between respective modules can be uni-directional or bi-directional depending on particular requirements for information transfers between those modules. Each module will be configured to handle different functionalities and interact with other modules as part of their roles. The different modules will now be described.

The Web Sales Module 901 may be provided as an initial point of contact for customers interested in having a new building constructed by a building construction company operating the building management system 900. The Web Sales Module 901 will typically provide a web interface that can be accessed by customers through a web site of the building construction company. The Web Sales Module 901 may be configured to provide customers with the ability to review and select from available building designs as a first step towards engaging the building construction company to construct a building in accordance with the customer's particular requirements.

Accordingly, in one embodiment the Web Sales Module 901 may include a range of design selection tools which can allow a customer to search through the available designs by entering one or more desired design attributes, such that a filtered subset of the available building designs meeting the design attributes will be presented to the customer for further review. Examples of design attributes may include Name, Type, Location, Price Range, Size, and numbers of Bedrooms, Garages, Bathrooms, Storeys or the like. It will be appreciated that the aforementioned list of design attributes is not exhaustive and the Web Sales Module 901 may be configured to allow searching based on any design attributes that can be associated with the available designs.

In any case, the customer may be presented with a list of results of designs having the desired design attributes identified by the customer in the search, and the customer may then review further details of the designs. Typically the customer may also have an opportunity to further refine the search to narrow the list of results, or to start another search.

The Web Sales Module 901 may also provide options for the customer to request an appointment or obtain detailed product information regarding a design of interest, after selection through a search as outlined above.

In the event the customer is interested in proceeding with having a building constructed based on one of the available designs, the customer will typically seek an estimate for the building construction. The Web Sales Module 901 may be configured to interface with a Sales Estimating Module 902 to allow details of a design selected in the Web Sales Module 901 to be transferred to the Sales Estimating Module 902 for allowing an estimate to be prepared.

The Sales Estimating Module 902 will typically be configured to allow an estimate of the costs for the building, in accordance with the selected design. This can include a capability to electronically prepare a detailed and accurate quote for the customer, utilising the latest pricing available for all items specified in the selected design. Thus, the customer can obtain a quoted total cost for the construction of the building, when the customer makes an enquiry. It will be appreciated that this will typically involve the estimating method discussed above.

The Sales Estimating Module 902 will typically be used by a sales representative during an appointment with the customer enquiring about having a building constructed based on a selected standard building design. Whilst it may be possible to prepare a quote without customisation of the selected design, generally the customer will have an opportunity to customise the selected design in some manner. These design customisations may range from relatively simple decisions regarding material type or colour options for materials used in the construction of the building through to significant changes in the structural configuration of the building.

The Sales Estimating Module 902 will preferably be capable of preparing the quote taking such design customisations into account. It will be appreciated that customisations such as material type or colour selections may have a reasonably straightforward impact on the estimated cost, whereby pricing associated with the selected material type/colour will be reflected in the estimate. For customisations beyond mere selections from material type/colour options, the calculation of estimated costs may require the sales representative to specify items or materials to be added/removed/substituted in the selected design. Customisations that have an impact on the building structure may go beyond the scope of customisations which can be automatically accounted for in the estimates prepared by the Sales Estimating Module 902, in which case these may require significant revisions to the building plan.

In any case, the Sales Estimating Module 902 will transfer information to the Final Estimating Module 905 to allow the preparation of final estimates, such as for the purpose of a building contract including pricing agreements, and the Construction Documentation Module 903.

The Construction Documentation Module 903 will typically be configured to receive details of the selected design along with options and/or customisations specified by the customer from the Sales Estimating Module 902. In one embodiment, upon receiving details of the selected design the Construction Documentation Module 903 will import a standard plan corresponding to the selected standard building design from a database and this standard plan will form the basis for the generation of the customised plan and other construction documentation, such as a bill of materials for the construction of the building in accordance with the customer's desired design customisations.

The Construction Documentation Module 903 may be integrated with Computer Aided Drafting (CAD) software for the generation of the customised plan. In preferred embodiments, at least some of the options and/or customisations specified by the customer may be automatically incorporated into the baseline plan by the Construction Documentation Module 903, although in some cases which require significant design customisations a draftsperson may need to revise the plan manually using the CAD software. In any event, the use of modern CAD drafting software will also facilitate automated updates of the bill of materials based on the plan drawings.

In one embodiment, the Construction Documentation Module 903 may be configured to carry out an automated comparison between the quote output by the Sales Estimation Module 902 and the customised plan output by the Construction Documentation Module 903 to ensure that the customised plan reflects all the desired design customisations specified by the customer as part of the sales estimating process, which formed the basis for the sales estimate. This can help to reduce the risk of the plan being finalised for construction without including design customisations requested by the customer, and thus avoid costly rework if such omissions are not discovered until later in the construction process.

A 3D Printing Module 904 may be provided to enhance the sales process. The 3D Printing Module 904 is configured to received the customised plan generated by the Construction Documentation Module 903 and provide this to a 3D printer to allow a physical representation of the customised building to be made. Depending on the 3D printer technology used, the physical representation may be made from plastic or any other suitable material that can be used by the 3D printer. It will be appreciated that this provides a capability for the customer to visualise the building before committing to construction. This can provide a valuable sales tool which can increase customer referrals to the company operating the system.

The Final Estimating Module 905 will received estimate information from the Sales Estimating Module 902 along with the plan, bill of materials and any other required construction documentation provided by the Construction Documentation Module 903. The Final Estimating Module 905 is then able to utilise this information to generate a firm, final estimate for the customised building design, taking account of any further design modifications required in preparing the plan which were not fully accommodated in the automatic generation of the estimate during the sales estimating process. The Final Estimating Module 905 will also interface with the Supervisor/Supplier/Trade Web Portal Module to allow the final estimate to reflect up-to-date cost information supplied by material suppliers, installers or the like.

Particular functionalities that can be provided in the Final Estimating Module 905 may include the following. The Final Estimating Module 905 may provide the capability to received the current bill of materials from the CAD software in accordance with the plan. It may also be used to generate Purchase Orders that can be issued to suppliers/installers in accordance with the final estimate, and there will typically be a capability to update the final estimate in accordance with supplier/installer quotes, rather than only relying on stored cost information. In one example, cost information associated with the different material elements can be updated at the time of generated the final quote by obtaining current material prices directly from the suppliers, to avoid the risk of out of date stored cost information being used in the final estimate.

The Final Estimating Module 905 may include Quantity Calculators and Material Calculators which can allow reporting of other particular details that may be useful in determining the final estimate or confirming its accuracy. The Quantity Calculators may be used to report minimum order quantity requirements (which may result in increased costs beyond the basic cost for obtaining only the quantity of material needed for constructing the building), and can be configured to flag minimum order quantity requirements outside of acceptable levels. The Material Calculators may be used to check that all materials are reflected in the final estimate, and can be configured materials missing from the estimate.

The Customer Relationship Management (CRM) Module 906 may be provided to handle communications with the customer throughout the construction process. This module may have a range of different functionalities for streamlining communications with customers, including capabilities for electronic document management, providing notifications to customers (using SMS/email or other suitable technologies), keeping records of individual remarks/instructions for each customer, recording detailed customer information, preparing standard letters using such information and managing customer appointments. Customer information may includes customer contact details, customer specified site requirements, contracts, bank details/contacts, progress payment details, or the like.

The Customer Relationship Management Module 906 may interface with a range of other modules as part of its functionalities. It may receive construction documentation from the Construction Documentation Module 903, provide payment details or the like to an Accounting Module 907, and transmit/receive information with a Customer Web Portal Module 908 which allows direct customer interface with the system.

The Accounting Module 907 handles accounting aspects of the system, whether this is in relation to receiving payments from the customer, or handling payments to/from suppliers, installers or the like. The Accounting Module 907 can interface with the Customer Relationship Management Module 906 to receive customer payment details or the like, and can be configured to facilitate and receive payments via the Customer Web Portal Module 908. Similarly, the Accounting Module 907 can interface with the Supervisor/Supplier/Trade Web Portal Module to facilitate payments to suppliers, installers or the like.

The Accounting Module 907 may be particularly configured to provide functionality such as managing payments in relation to purchase orders or progress payments linked. The Accounting Module 907 may also interface with the Building Construction Module 909 to check purchase orders against tasks in the schedule to ensure these tasks are completed before payment is made. Payments can be cross checked to avoid duplications, and invoices can be checked with actual purchase order amounts to ensure payments are correct.

The Customer Web Portal Module 908 provides a convenient interface for the customer to access information relating to the construction process and to perform related actions such as making progress payment. As its name implies, the Customer Web Portal Module 908 will generally be provided as a website which the customer can access using any suitable internet-enabled client processing system 203. The customer can use the Customer Web Portal Module 908 to access indications of construction progress, download documents associated with the construction progress, and make progress payments at construction milestones as required.

Furthermore, the Customer Web Portal Module 908 may remain accessible to the customer after construction has been completed to allow ongoing useful functionalities throughout the lifecycle of the building. In particular, the Customer Web Portal Module 908 may interface with a Maintenance/Warranty Module 911 for allowing the customer to access maintenance and warranty functions. For instance, the customer may use the Customer Web Portal Module 908 to lodge a warranty claim for a failure during the covered warranty period. Even if the warranty has expired, the customer can request maintenance through the Customer Web Portal Module 908 which can allow the customer's request to be conveniently provided to the original supplier/installer. It will be appreciated that this can streamline the customer's experience in the event of a failure since the customer will not need to investigate the best person to contact and can be reassured that the original supplier/installer will be familiar with the materials requiring the maintenance.

The Building Construction Module 909 will generally facilitate the overall project management of the building construction process. Accordingly, this module will be used for generating the customised schedule as discussed above and for the ongoing maintenance of the schedule to reflect progress. The Building Construction Module 909 may also be configured to interface with a number of different modules to share progress information as required.

For example, the Building Construction Module 909 may interface with the Final Estimating Module 905 to receive a final estimate and the corresponding version of the customised building model which will specify the configuration of the building to be constructed. Similarly, the Building Construction Module 909 may interface with the Construction Documentation Module 903 to receive the final plan, bill of materials and other generated construction documentation to allow construction to proceed.

Other interfaces depicted in FIG. 9 include two-way interfaces with the Supervisor/Supplier/Trade Web Portal Module 910 and the Customer Web Portal Module 908 for allow ongoing construction progress information to be made available to Supervisors/Suppliers/Trades and Customers. The Building Construction Module 909 may also interface with the Maintenance/Warranty Module 911 to ensure Maintenance/Warranty records can be updated to reflect the final construction of the building, and with the Accounting Module 907, such as to allow invoices to be raised at predetermined progress stages in the construction project.

The Supervisor/Supplier/Trade Web Portal Module 910 provides a web portal similar to the Customer Web Portal Module 908 but tailored to provide particular information to Supervisors/Suppliers/Trades during the construction process, or at any time after construction. Access to information will typically be controlled depending on the responsibilities of the particular user, so that a user will only be able to access relevant information.

The Supervisor/Supplier/Trade Web Portal Module 910 may provide, for example, access to purchase orders and/or other documents. In one example, the Supervisor/Supplier/Trade Web Portal Module 910 may allow the user to input information regarding progress on assigned tasks or to access construction documentation relevant to such tasks. This module may also allow a user to see the progress of other aspects of the project, to assist in planning upcoming work for the project. The Supervisor/Supplier/Trade Web Portal Module 910 may provide a convenient overview of current assigned work and may provide an indication of priority.

The Supervisor/Supplier/Trade Web Portal Module 910 can interface with many of the other modules to ensure the relevant information is available to the users and to allow the system to properly account for inputs as these are received. For example, an interface with the Final Estimating Module 905 allows up to date material cost information to be requested from Supervisors/Suppliers/Trades during the generation of the final estimate and in turn allows this to be incorporated into the estimate when received.

As mentioned above, the Supervisor/Supplier/Trade Web Portal Module 910 may interface with the Building Construction Module 909 to allow updates on progress, and with the Maintenance/Warranty Module 911 for ongoing maintenance/warranty actions following the completion of construction. An interface with the Accounting Module 907 may also be provided to facilitate the payment of Supervisors/Suppliers/Trades.

As mentioned above, the Maintenance/Warranty Module 911 may handle ongoing maintenance/warranty actions following the completion of construction. Customers may use the Customer Web Portal 908, with which the Maintenance/Warranty Module 911 interfaces, for the purpose of raising maintenance for materials/equipment from responsible Supervisors/Suppliers/Trades. In turn, the Maintenance/Warranty Module 911 interfaces with the Supervisor/Supplier/Trade Web Portal Module 910 to facilitate engagement of the appropriate Supervisors/Suppliers/Trades. Thus, details of maintenance issues and associated job requests or the like for rectifying these may be sent directly to an assigned supplier or subcontractor.

Furthermore, the Maintenance/Warranty Module 911 may be configured to provide a convenient store of warranty information which can be made available to the customer via the Customer Web Portal 908. It will be appreciated that this can greatly assist the customer since the customer will no longer need to retain their own warranty-related records.

In addition to the interconnected modules forming the system 900 as described above, there are two additional modules which are provided to perform important underlying management functions across all of the other modules.

The Management/Reporting Module 912 is provided to facilitate the management of both administrative and construction processes. Accordingly, this allows personnel having management responsibility to obtain an overview of progress of the project along with ongoing activities handled by all of the modules. For example, the Management/Reporting Module 912 may allow progress updates regarding the completion of scheduled tasks to be made directly available to administrative office staff and managers overseeing the performance of Supervisors, Suppliers and Trades.

Furthermore, the Management/Reporting Module 912 can allow comprehensive reporting on a range of aspects, such as the Project Management for the building, tracking of tasks, accounting and the like.

The Quality Management Systems Module 913 is provided for ensuring compliance with quality management requirements, such as ISO 9001 Quality Management Systems Requirements. This module may also have interfaces with the other modules as required for such compliance. It will be understood that the use of the building model and ability to generate construction information using this building model in a computerised environment can greatly assist the Quality Management of a construction project.

Further optional features relating to the use of a construction model, such as a building model, in the management of the construction process will now be described. Again, for the purpose of assisting explanation the following discussion is provided in the context of a building construction project but it will be understood that the described features will apply more generally to other types of construction projects.

As discussed, the generation of schedules in accordance with the methods above may involve the use of a template schedule for the standard building design. In one example, respective template schedules will be predefined for each available standard building design and these will include standard tasks associated with the construction of a building, in accordance with the standard building design. In addition to these standard tasks, the template schedules will also include standard links or lags between at least some of the standard tasks, to therefore define relationships between the standard tasks in the overall context of the construction project.

Each new project may use one of these predefined template schedules. In the event there are no design customisations, the project may proceed directly using the template schedule, however this is rarely, if ever, the case. In the more frequently encountered situations where design customisations are required, these may be accounted for by having the template schedule modified by the system. Typically, this involves having software determine required modifications to the template schedule based on specific material properties and/or tasks associated with materials required for the design customisations.

It is noted that a standard building design will usually represent a minimum baseline configuration of the building such that design customisations will more commonly involve the addition of material elements or changes to existing material elements as opposed to the removal of material elements. It is also noted that the addition of material elements carries the highest likelihood of impacting on the schedule, due to this typically requiring additional work to incorporate the material elements into the construction of the building.

Additive design customisations can be readily accommodated using the template schedule through the addition of tasks associated with incorporating the material elements added by design customisations to the standard tasks present in the template schedule, in the form of sub-tasks which are coupled to the standard tasks.

Typically, these sub-tasks are added as one of the following three types. A first type of sub-task is an advice sub-task, which will be included in the schedule to allow the sub-task to be displayed and considered throughout the project but which will have no particular impact on the completion of the project. A second type of sub-task is a critical sub-task, which must be completed before subsequent tasks can proceed, thus representing a part of the critical path of the schedule. Later tasks in the project will thus be dependent on these types of sub-tasks. Finally, a third type of sub-task is a non-critical sub-task, which will not hold up subsequent tasks, although sub-task must still be completed before the overall project can be completed. The respective types of the sub-tasks can be defined when the customised schedule is generated, and in some cases, the template schedule may include existing sub-tasks with types already be assigned.

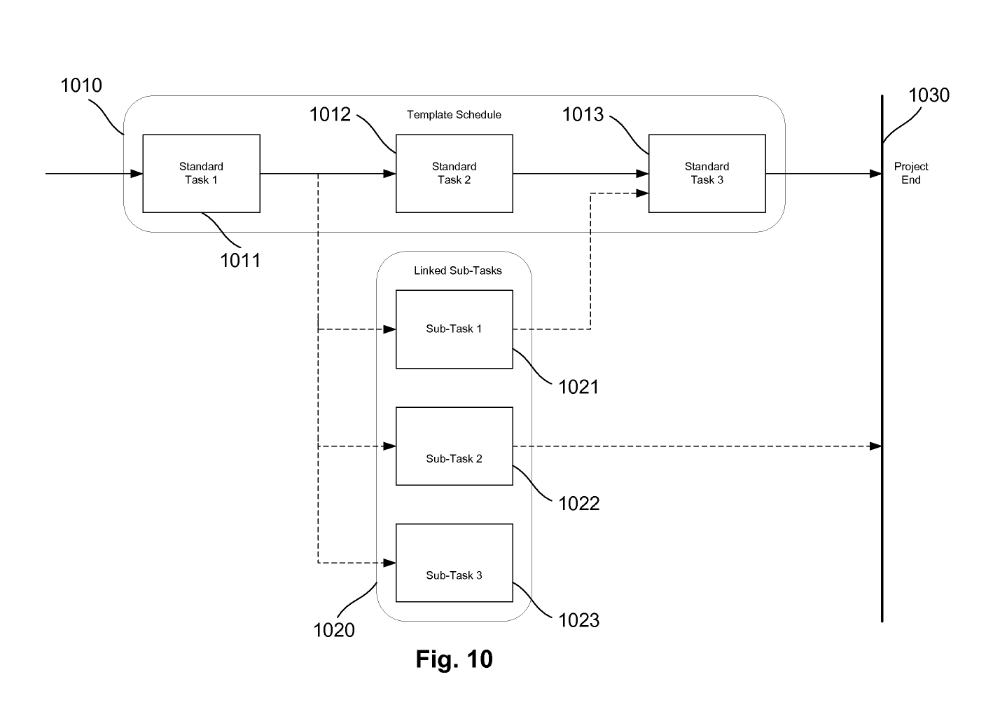

An example illustrating how sub-tasks may be linked to a template schedule will now be described with reference to FIG. 10. In this example, a simplified portion of a template schedule 1010 is provided which includes three Standard Tasks 1011, 1012, 1013 linked together in series. The end of the project 1030 is dependent on the completion of each of the Standard Tasks 1011, 1012, 1013 as shown.

A set of linked sub-tasks 1020 have been added to the template schedule 1010 in this case. In particular, there are three sub-tasks 1021, 1022, 1023, which are each dependent from the first standard task 1011 but are of different types in order to illustrate those discussed above.

The first sub-task 1021 is a critical sub-task which is linked to the third standard task 1013 and must be completed before that standard task 1013 can commence (and thus before the project can be completed. The second sub-task 1022 is a non-critical sub-task and thus is only linked to the end of the project 1030 but no other tasks are dependent from this sub-task 1022. Finally, the third sub-task is an advice sub-task which will usually only be visible when current or for a predetermined number of days, and has no links to later tasks or the end of the project 1030.

As per conventional scheduling methods, resources (such as personnel) can be assigned to tasks and sub-tasks within the schedule, and known techniques can be used to determine total resource usage at different stages of the project. A user is able to interact with the schedule to view only the resource assigned to a particular sub-task. In some implementations, when the level of resource assigned to a sub-task is changed, the finishing time of the sub-task will be adjusted accordingly, allowing a project manager to manipulate the assignment of resources to control the finishing time of tasks throughout the construction process.

In some examples, it is also possible to selectively enable or disable standard tasks within a template schedule, which provides the opportunity to accommodate large scale additions or removals of material elements due to design customisations. In any event, it will be appreciated that the provision of a template schedule with standard tasks as described above will allow customised schedules to be generated with improved efficiency in according with the methods exemplified above.

As discussed, the generation of construction information involves the use of a building model including material elements which are each associated with material properties. Typically, each material element has the ability to be linked to multiple material properties. These material elements may be referred to as “smart materials” as their material properties can be associated with a range of different types of information associated with the construction of a building using those materials.

In some implementations, the material properties will have key roles throughout the construction process, with the ability to trigger specific actions at suitable stages during construction, usually in response to events such as the completion of a stage of construction or any other defined event. The actions may, for example, involve the generation of documents or notifications used to manage the construction process. This will be achieved by having different modules of the system use the material properties making up the building model, as required during the construction process.

In general terms, this triggering behaviour may involve having the material properties of at least some of the material elements of the building model include a trigger for triggering, in response to an event, one or more actions during the construction of the building. In particular embodiments the triggering behaviour will involve receiving an event indication for an event that has occurred during the construction of the building and determining one or more actions to be performed in response to the event, in accordance with one or more triggers of the material elements of the building model.

In preferred implementations, an Event Processor Agent (EPA) may be provided for receiving the event indication for the event, processing the event indication in accordance with predetermined processing rules to determine one or material elements including triggers for one or more actions in response to the event and causing the action to be performed.

Such techniques may be used to trigger a range of actions including, for example, generating a task in the schedule, generating or modifying a document and generating a notification.

In the case of generating/modifying a document, the document may be, for example, one of a quality assurance document, a safety plan document, a certification document, an inspection document and a contract document. Such generated documents may be stored in a store, such as the database 211 of the server processing system 201. The method may further include delivering the document to a recipient selected based on a type of the document. In the context of the system 900 discussed above, the document may be delivered, for example, via the Customer Web Portal Module 908 or the Supervisor/Supplier/Trade Web Portal Module 910 depending on the intended recipient.

In some implementations, documents may be generated such that they include a barcode, so that a user can scan the barcode to indicate compliance with the document. For example, a document relating to an inspection may include a barcode which can be scanned when the inspection is complete. In such implementations, the method may include obtaining details of the scanned barcode and generating an event indication corresponding to the compliance with the document. Thus, the event indication can be used to trigger subsequent events based on other material properties.

As mentioned above, an Event Processor Agent (EPA) may be used to process events as these occur during construction and interact with the material properties to allow particularly actions to be triggered using the material properties. In one example, the EPA operates in accordance with predefined event processing rules to determine when particular actions will be triggered, and passes the appropriate material properties to designated modules of the system. When an estimate is created for the construction of a building, only the material elements including in the customised building model used in the estimate are then used for the defined action rules to execute the required actions.

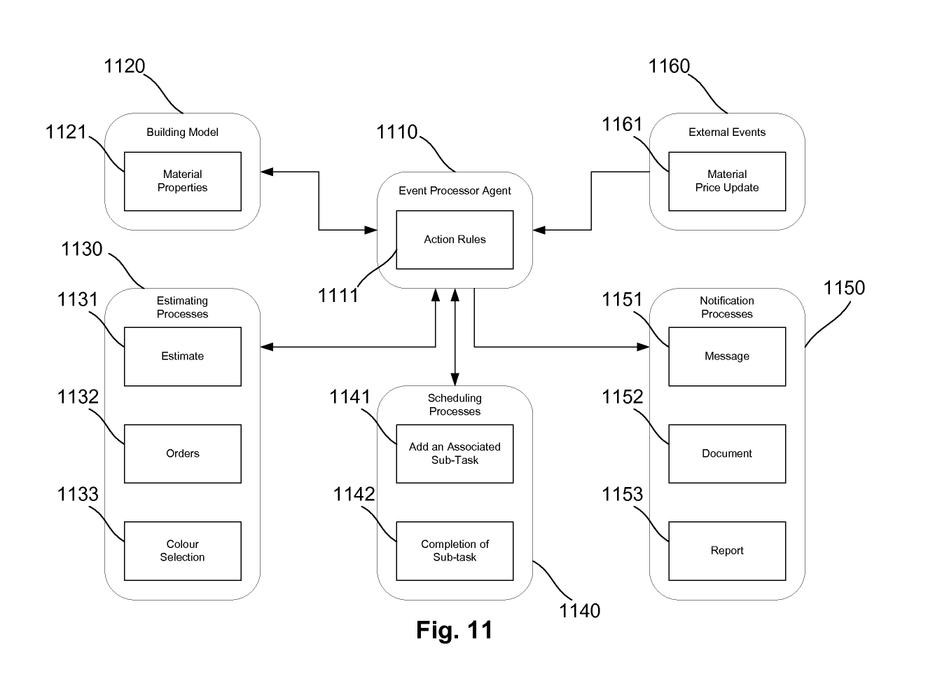

An illustrative example of how an EPA may be implemented will now be described with reference to FIG. 11. In this example, the EPA 1110 operates based on predefined Action Rules 1111, in order to respond to trigger events with suitable actions.

For example, the EPA 1110 may respond to trigger events arising from the Building Model 1120, such as due to changes in Material Properties 1121 of the material elements defining the Building Model 1120. The Action Rules of the EPA will typically cause certain actions to be performed depending on the particular changes in the Material Properties 1121. For instance, a change in a cost attribute of one of the Material Properties 1121 may trigger the EPA to cause an action in the Estimating Processes 1130 of updating the Estimate 1131 to reflect the change in the cost attribute.

The Estimating Processes 1130 may also have other actions triggered by the EPA 1110 such as the generation of Orders 1132. In addition, the Estimating Processes 1130 may be responsible for initiating trigger events, such as when a customer makes a Colour Selection 1133, to which the EPA 1110 will respond by causing an update to the appropriate Material Properties 1121 in the Building Model 1120.

The EPA 1110 may also respond to External Events 1160 such as Material Price Updates 1161 which may be received from suppliers, subcontractors or the like. For instance, the EPA may cause an event of having the corresponding Material Property 1121 updated in the Building Model 1120, which may in turn trigger a subsequent update of the Estimate 1131 as discussed above.

As shown, the EPA 1110 may also respond to triggers from, or cause actions to be performed the Scheduling Processes 1140. For example, the EPA may cause the Scheduling Processes 1140 to Add an Associated Sub-Task 1141 into the schedule, which may be triggered by a change in schedule attributes of a Material Property 1121 or the addition of a new material element having a Material Properties 1121 including an associated sub-task that needs to be incorporated into the schedule. The EPA 1110 may also cause an action in the Scheduling Processes 1140 to update the schedule upon Completion of a Sub-task 1142. Conversely, the Scheduling Processes 1140 may initiate a trigger event upon the Completion of a Sub-task 1142, which will be received by the EPA 1110 and may cause a Message 1151 to be sent as part of the Notification Processes 1150.

The EPA 1110 may also trigger a range of actions in the Notification Processes 1150. For instance, the Notification Processes 1150 may generate Messages 1151 in the form of SMS messages, emails, facsimiles, mail, file transfer protocol uploads or the like. These Messages 1151 may be automatically sent to different recipients such as a customer, supplier, subcontractor, supervisor or management personnel, depending on the particular Message 1151 and the particular triggering event which caused it to be generated. Other actions which may be performed by the Notification Processes 1150 in response to trigger events may include the generation or update of Documents 1152 or the generation of Reports 1153. It will be appreciated that similar Notification Processes 1150 may be utilised by different modules in the example of the modular system used to implement the methods described above.

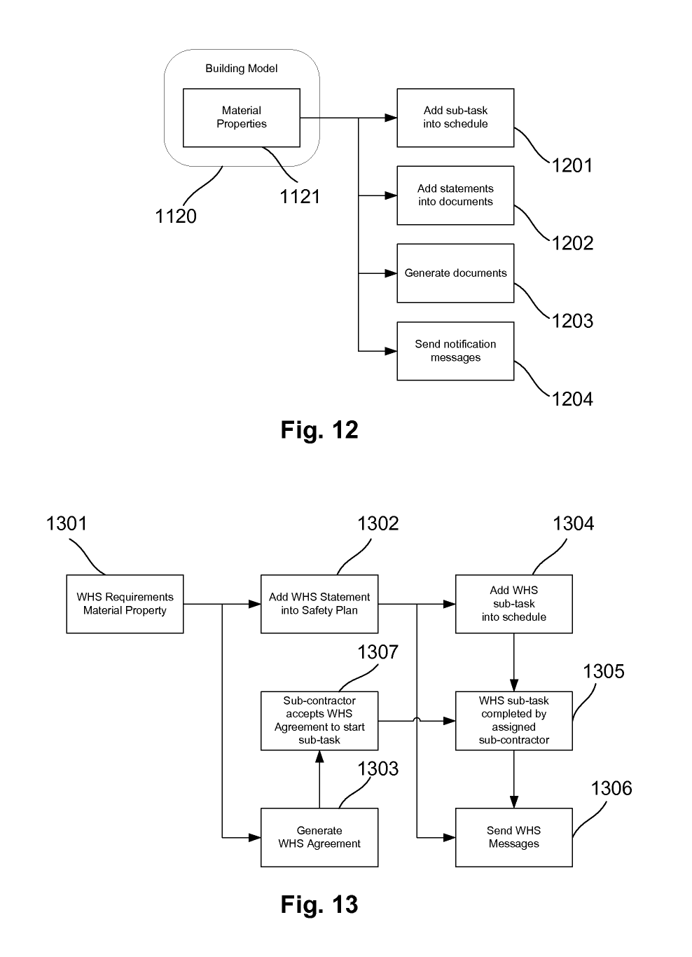

In view of the above, and with reference to FIG. 12, it will be appreciated that Material Properties 1121 in the Building Model 1120 may trigger actions such as adding a sub-task into the schedule as shown at 1201, adding statements into documents as shown at 1202, generating documents as shown at 1203 and sending notification messages as shown at 1204. The specific actions triggered by particular material properties will ultimately depend on the type of the material properties.

Whilst some examples of material properties have already been discussed above, such as cost attributes which are used in generating estimates, a wide range of different material properties can be used which will extend the usefulness of the method to other parts of the construction process.

It will be appreciated from the above examples that the material properties may include schedule attributes which are used in generating schedules, such that material elements forming part of the customised building model and costed in the estimate can have corresponding project sub-tasks added into a template schedule to generate the customised schedule. The material properties can also include resource information that can be used to assign a selected resource, such as a subcontractor, for installing the corresponding material.

Other material properties for a particular material element can allow Workplace Health and Safety (WHS) requirements and Self Certification for the material to be made available to the subcontractor. Specific information relating to the correct installation of the corresponding material can be documented and made easily available, by capturing this information (or links to suitable sources of such information). Furthermore, the material properties may be used to allow appropriate contractual text to be automatically incorporated into the customer's building contract, in accordance with the material elements used in the building model.

Further examples of different types of material properties that may be provided for material elements in the building model will now be discussed. It will be noted that whilst these types of material properties are described in the context of building construction projects, many of these will also be applicable to other types of construction projects.

Self Certification material properties may be provided to aid subcontractors/personnel in certifying work they have completed in relation to installing corresponding materials. In one example, these include a list of defined points for a particular trade to check that work is completed to a required standard. The Self Certification material properties may be used in the generation of a Self Certification document for one or more materials, which will need to be approved by the trade before the system can accept that the work is completed.

Inspection/Checks material properties can function similarly to self certification material properties as discussed above, but will generally relate to a list of defined points for Supervisors or other suitably qualified third parties to inspect work completed by the various trades, and usually relate to more significant safety/quality requirements than for self certification.

Colour Selection material properties may be provided to indicate available colours for the material, and once a selection is made, these Colour Selection material properties will store the selected colour to ensure generated construction information reflects this colour selection. Thus, this can reduce the risk of installing materials having an unwanted colour. To further assist the colour selection process, a Colour Selection Image may be provided with the colour selection material properties, which can aid customers with the colour selection process. For example, a customer may be presented with Colour Selection Images for particular materials as part of the selection of design customisations during an estimating process.

Associated Sub-Task material properties may be provided to facilitate the generation of a schedule as discussed above. These material properties may include multiple associated sub-tasks for different stages of the construction process. Each associated sub-task will be added to the schedule for use in project managing the construction process. The resource associated with each sub-task may be determined using other material properties, such as a vendor code material property.

Vendor Code material properties define the different trades and/or suppliers which may be required for the installation of the corresponding material. The trades and/or suppliers may be divided into groups by the type of work they perform or type of materials they supply.

Map Area material properties can be used to define a geographical area on a map to show delivery options available for the material. Thus, these material properties can allow generated estimates and schedules to account for logistics aspects.

Cost of Delivery material properties are provided to define the delivery charges associates with the material, and may include minimum delivery charges and different charge rates based on the quantity of material ordered or the delivery distance.

Combined Delivery material properties may be defined when the associated material can be delivered with other materials, such as when supplied by the same vendor (for example, bricks and tiles may have their delivery costs combined).

Key Features material properties can be used to capture specific key features relevant to each material. They are a required property which helps define the particular characteristic of each material. For example, for a toilet the key feature may be a toilet offset measurement, for a door the key feature may be width, or for a vanity this may be the overall size. These key features may be used by the system to group materials with same key features. It is noted, however, that the key features material properties are not provided to exhaustively list dimensions. Rather, the value of the key feature will be used by the trades to help with installation. For example, the toilet offset measurement of a toilet S bend will help a plumber with exact slab penetration measurement, and thus if this is provided as a key feature for the toilet it may be used in the generation of instructions for the plumber to ensure this measurement is adhered to.

Discount Level material properties are a form of cost attributes that can define the amount of discount to be used for the material. This may be useful, for example, where a large number of buildings using the same materials are expected to be constructed such that bulk discounts may be applied to the material purchase costs.

Customer Choice material properties allow the assignment of customers to purchase the associated material at different rates, and thus can also have an impact on costing.

Special Requirements material properties allow the definition of any other special requirements pertaining to the associated material for handling or installation. These special requirements may then be used in the generation of other construction information as required.

Valid Date material properties may indicate a date when the current price for the associated material will expire. This may be useful to ensure cost estimates are prepared based on up to date pricing.

List Substitutes material properties can be used to defined a list of other materials which can be substituted for the particular material. This can be useful in the event of a material unavailability situation as this can allow rapid substitution without the need to seek approvals or the like.

Contractual Requirements materials properties may include any text to amended to building contract in relation to this material. Thus when a building contract is generated using the system, this text may be automatically incorporated.

WHS Requirements materials properties may define particular workplace health and safety requirements relating to the material, as mentioned above. These can be used to ensure the workplace health and safety requirements are reflected in relevant documentation such as work instructions when these are generated.

Proprietary Barcode material properties relate to information for embedding in a barcode for identifying the material and selected properties of the material. This may allow a barcode to be assigned to the material and printed on documentation or labels to allow a convenient means of inputting information to the system in relation to the material, by scanning the barcode. For example, the barcode for the material may be printed on a work instruction document provided to a subcontractor for installing the material, so that the subcontractor can scan the barcode using a mobile device configured as a client processing system 203, to thereby input to the system confirmation that the material has been installed

Group Name materials properties may be used to allow similar materials to be grouped together, such as for the purpose of ordering a number of different materials in the same group.

Other Material Link material properties may be used to identify materials which also need to be used if this material is used. For example, for a material element associated with an air conditioning unit, there will be a requirement for other material elements associated with materials used in the installation of the air conditioning unit, such as piping or conduits.

Australian Approvals Information material properties may be used to provide information relating to Australian Approvals for the material.

Type-Labour/Supply material properties may be used to describe whether the material element relates to a material that requires labour to produce or is supplied as is.

Work Instruction material properties may be used to specify instructions for installation of the material, and in some cases may also include work instructions for other trades as need to allow for required modifications for allowing the material to be installed.

Illustrative examples of the use of different material properties in triggering different types of actions will now be described.

FIG. 13 particularly shows an example in which actions are triggered by a WHS Requirement Material Property 1301. As mentioned, The WHS Requirement Material Property 1301 can be added to any material element included in a building model. The WHS Requirement Material Property 1301 may include a short WHS Summary, The Safety Plan, and a detailed WHS Statement which describes the WHS requirements of the corresponding material.

When the material element having the WHS Requirement Material Property 1301 is used in the building model, and processed during the generation of an estimate, the WHS Requirement Material Property 1301 triggers actions for communicating relevant WHS requirements and related information to the people involved with the use of the material during the construction process. (i.e. Supervisors, Sub-contractors, Installers, Inspectors, etc.). The particular actions triggered in this example are as follows.

The detailed WHS Statement will be added a Safety Plan document at 1302 and a WHS Agreement document will also be generated in accordance with the WHS Statement at 1303. The WHS Agreement may be provided to the assigned sub-contractor via the Supervisor/Supplier/Trade Web Portal Module 910. WHS Messages may be sent to the assigned sub-contractor at 1306 which may prompt them to check for the WHS Agreement.

The WHS Statement added into the Safety Plan may in turn lead to the addition of WHS sub-tasks into the schedule at 1304. Before the Installer can start work with the material, they will need to accept the conditions of the WHS Agreement for the material as shown at 1307. It is only then they will be able to complete the WHS sub-task associated with the material at 1305, along with any other sub-tasks for installing the material. WHS Messages with the summary or detailed WHS statements can be sent via SMS/email/fax/mail on use of the material and when sub-tasks for the material are completed, as shown at 1306.

Similar triggering arrangements may apply to other types of material properties such as Self Certification material properties and Inspection/Checks material properties as discussed above.

With regard to Self Certification material properties, these may include Self Certification Requirements which may be in the form of a list of requirements that must be met to allow certification of installation/work in relation to the material. When a material having Self Certification material properties is included in a customised building model, and an estimate is generated, this triggers processes in order to communicate the Self Certification Requirements information to the people involved with this material (i.e. Supervisors, Sub-contractors [Installer/Inspector])

Particular actions triggered are similar to those discussed above for the WHS Requirement material properties, albeit with adaptations specific to Self Certification. For instance, in the case of Self Certification material properties, a Self Certification Requirements statement will be added to a Self Certification document. The Self Certification Requirements statement will be made available to the Installer/Inspector using the Supervisor/Supplier/Trade Web Portal Module 910 to allow the statement to be viewed/downloaded.

Any sub-tasks needed for Installer/Inspector in relation to the particular Self Certification Requirements will be added to the Jobs Project Schedule. Before the Installer can mark the work associated with the Material as completed, they will need to accept the Self Certification Requirements for the Material. Messages with the Self Certification Requirements can also be sent via SMS/email/fax/mail regarding the use of the material and when project tasks for this material are completed.

Generally similar actions may be triggered for other types of material properties, such as Inspection/Checks material properties, Australian Approvals Information material properties, Special Requirements material properties, and the like.

It will be appreciated that construction projects will typically involve the use of a significant number of different types of materials having corresponding material elements within the construction model. Furthermore, each of these material elements will have a plurality of associated material properties, which may need to be maintained to ensure these reflect up-to-date construction attributes. For instance, cost attributes within the material properties will often be subject to fluctuations due to supplier pricing changes, installation labour cost changes, or the like, prompting regular updates of the material properties.

However, manually maintaining the material properties for each material element across a range of construction projects may be a tedious and time consuming task. Accordingly, it may be desirable to facilitate at least semi-automated maintenance of the material properties. This may allow, for instance, price changes from a supplier to be rapidly applied to material elements used across all construction projects.

In one example, material properties for a plurality of different materials elements may be maintained simultaneously, rather than needing to maintain material properties for each material element separately. For instance, material properties may be classified based on shared characteristics of the material properties. Then, a range of different material elements with material properties falling under the same classifications may have at least some of their material properties updated in a batch process, to thereby maintain those material properties.

For instance, material properties may be classified under the categories of common, numerical or unique material properties, which will be discussed in further detail below.

Common material properties are those which are shared across multiple material elements, such that an update to common material properties will typically apply to all of the relevant material elements. Thus, maintenance of these common material properties may be performed rapidly be rolling out an update across any material elements to which those common material properties apply. An example of a common material property may include work instructions that apply to a range of related material elements.

Numerical material properties are those which have numerical values and thus may be updated using mathematical operations which can be rapidly applied to multiple entries. Material properties reflecting cost attributes would usually be classified as numerical material properties, although it will be appreciated that other types of material properties may include numerical values. In one example, numerical material properties for a plurality of material elements may be rapidly updated to account for price changes by applying a percentage increase to the numerical values of the numerical material properties.

Unique material properties will be the remaining material properties which only apply to a specific material element, and thus will need to be updated individually. For instance, a particular material element may involve specific WHS Requirements material properties that do not apply to any other material elements. Ideally, the number of unique material properties for any material element will be minimised to reduce the amount of manual activity that may be required to maintain its material properties.

As mentioned above, the numerical material properties can facilitate rapid updates across a batch of material elements to reflect commonly applicable price changes. For instance, a supplier may revise their prices for some or all of the materials they supply, to reflect increased material costs or the like. These price revisions may be readily rolled out onto any projects using those materials by applying suitable operations on the respective numerical material properties of the corresponding material elements.

It will be appreciated that this can help to reduce or avoid excess time spent manually updating material properties. The use of material properties in this fashion also avoids the need to upload all data for each project, and rather allows central maintenance of material properties in an at least semi-automated manner. This can also ensure more reliable updates of cost estimates or other construction information across projects.

Material properties may also be grouped together based on other factors to further facilitate batch updating as discussed above. For instance, material properties may be grouped by particular trades, allowing trade labour cost changes to be applied across a group of material properties.

In some implementations, spreadsheets may be used to facilitate the maintenance of material properties as discussed above. Different tables may be established for different classifications of material properties. For instance, numerical material properties for at least a subset of material elements may be captured in a single table, such as to allow mathematical operations to be applied across related material properties in a column.

Updated supplier pricing information for a range of materials may be received from the supplier in an electronic format such as a list or table, and conveniently mapped to the material properties in the spreadsheets to facilitate rapid updates of the material properties. A conversion table or the like may be used to link/map the supplier pricing information to the material properties in a single formatting process. This can remove the need for suppliers to comply with specific formatting requirements and can instead provide information in their usual formats, yet still have this readily imported into the material properties.

In another aspect, material elements may include a material property identifying a unique identification code for the respective material, which may be based on an established international ID system or the like. Whilst supplier product numbers or the like may also be associated with the material element in respective material properties, these are unlikely to be unique to the material, since a particular material may be associated with a range of different supplier product numbers if it is supplied by different suppliers. However, the use of an established international ID for the material can remove supplier product number ambiguities and provide an overarching means of identifying a material irrespective of the supplier.

It will be appreciated that this can help to avoid duplicates of material elements associated with materials from different suppliers. Where different material elements are established for materials from different suppliers, such as to reflect different material properties specific to the suppliers, these can nevertheless be linked to a common underlying material element having the unique identification code and for which common material properties can be associated. Thus, any common material properties can be updated and automatically applied to other related material elements. Alternatively, a single material element may be used for the material and additional material properties may be entered for each supplier to reflect different supplier product numbers, pricing and so on.

The unique identification code may also be associated with material barcodes typically applied to materials by suppliers, allowing workers to scan a barcode when receiving or using materials to validate the material against the material element used in construction model. This material barcode may reflect the international ID or a supplier product number, since the material element can be identified on either basis assuming the material properties are defined appropriately.

As mentioned previously, the above described methods can be used to generate a building contract as one form of the construction information. In this regard, it is noted that this can advantageously allow a highly customised building contract to be generated, as opposed to the frequently large and onerous contracts currently used in the building industry to cover all scenarios even if these do not apply to a particular project. As a result of this method, a compact, tailored building contract can be generated that only reflects the particular conditions of the project. This can allow improved legal liability insurance.

In any case, it will be appreciated that the use of a construction model made up of material elements, which each include material properties configured to trigger particular actions as discussed above can allow for the automated generation of construction information during the construction process beyond only cost estimates and schedules. Furthermore, the method can be configured to respond to events throughout the construction process to thereby ensure appropriate tasks are completed for meeting requirements specified by material properties and facilitating improved management of the entire construction process.

Whilst the above methods may be provided as part of the functionality of an integrated construction management system that provides enhanced automation and quality assurance of the construction process, it will be understood that this need not be the case and that aspects described above may be provided separately as required, or in combinations other than those exemplified above.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

Persons skilled in the art will appreciate that numerous variations and modifications will become apparent. All such variations and modifications which become apparent to persons skilled in the art, should be considered to fall within the spirit and scope that the invention broadly appearing before described.

The claims defining the invention are as follows:

1) A method for managing a construction project, wherein the method includes, in one or more electronic processing devices:
a) for a selected standard construction design, retrieving a construction model for the standard construction design from a store, the construction model including a plurality of material elements representing materials for use in carrying out a construction project in accordance with the construction model, each material element having material properties including construction attributes;
b) determining one or more design customisations;
c) updating the construction model in accordance with the one or more design customisations to thereby generate a customised construction model, by at least one of:
i) adding one or more material elements;
ii) removing one or more material elements; and,
iii) modifying one or more material elements; and,
d) generating construction information associated with carrying out the construction project in accordance with the construction attributes of the customised construction model.

2) A method according to claim 1, wherein the construction information includes at least one of:
a) a cost estimate for carrying out the construction project; and,
b) a schedule for carrying out the construction project.

3) A method according to claim 2, wherein the construction information further includes at least one of:
a) a project duration;
b) a bill of materials;
c) a construction plan;
d) work instructions;
e) a contract clause;
f) a certification document; and,
g) a workplace health and safety document.

4) A method according to claim 1, wherein the construction attributes include at least one of:
a) cost attributes; and,
b) scheduling attributes.

5) A method according to claim 4, wherein the cost attributes include at least one of:
a) material costs;
b) delivery costs;
c) installation costs;
d) certification costs; and,
e) approval costs.

6) A method according to claim 4, wherein the scheduling attributes include at least one of:
a) a task;
b) a link to another task;
c) a criticality indication;
d) a required resource.

7) A method according to claim 1, wherein modifying a material element includes modifying a quantity of a respective material represented by the material element.

8) A method according to claim 1, wherein the method includes determining the selected standard construction design by:
a) providing details of a plurality of available standard construction designs in the store; and,
b) obtaining a user selection of the selected standard construction design.

9) A method according to claim 8, wherein the method further includes:
a) obtaining a user selection of a construction preference; and,
b) providing details of at least one of the available standard construction designs satisfying the construction preference.

10) A method according to claim 8, wherein the method includes determining the design customisation by:
a) providing details of a plurality of available design customisation options for the selected standard construction design; and,
b) obtaining a user selection of the selected design customisation.

11) A method according to claim 10, wherein the method includes:
a) determining a plurality of selected design customisations; and,
b) updating the construction model in accordance with the plurality of selected customisations.

12) A method according to claim 1, wherein generating the construction information includes generating a cost estimate for carrying out the construction of project, the method including:
a) retrieving a template cost estimate for constructing the selected standard construction design; and,
b) generating the cost estimate by updating the template cost estimate in accordance with the one or more design customisations.

13) A method according to claim 12, wherein the method includes, for each design customisation:
a) determining a cost variation associated with the design customisation; and,
b) updating the template cost estimate in accordance with the cost variation.

14) A method according to claims 1, wherein generating the construction information includes generating a schedule for carrying out the construction project, the method including:
a) retrieving a template schedule for constructing the selected standard construction design; and,
b) generating the schedule by modifying the template schedule in accordance with the one or more design customisations.

15) A method according to claim 14, wherein the method includes, for each design customisation:
a) determining a task associated with the design customisation; and,
b) modifying the template schedule to incorporate the task.

16) A method according to claim 15, wherein the template schedule includes a plurality of standard tasks for the construction of the selected standard construction design, at least some of the standard tasks being linked to one or more other standard tasks, the method including modifying the template schedule by linking the task associated with the design customisation to one or more of the standard tasks.

17) A method according to claims 1, wherein generating the construction information includes causing a plan for the construction to be generated, the method including:
a) retrieving a template plan for the construction of the selected standard construction design; and,
b) causing the plan to be generated by requesting that the template plan be updated in accordance with the one or more design customisations.

18) A method according to claim 17, wherein the method includes, for each design customisation:
a) determining a plan change associated with the design customisation; and,
b) requesting that the plan be modified to incorporate the plan change.

19) A method according to claim 18, wherein the method includes determining whether the plan change is in accordance with predetermined design parameters.

20) A method according to claim 19, wherein the method includes, in the event a plan change is not in accordance with predetermined design parameters:
a) triggering a review of the plan change prior to requesting that the plan be modified;
b) modifying the plan change to satisfy the predetermined design parameters to thereby generate a modified plan change;
c) requesting that the plan be modified to incorporate the modified plan change; and,
d) checking the plan following modification to ensure the modified plan change is incorporated.

21) A method according to claim 17, wherein the method includes generating a bill of materials in accordance with the plan.

22) A method according to claim 1, wherein the material properties of at least some of the material elements of the construction model include a trigger for triggering, in response to an event, one or more actions during the construction project.

23) A method according to claim 22, wherein the method includes:
a) receiving an event indication for an event that has occurred during the construction project; and,
b) determining one or more actions to be performed in response to the event in accordance with one or more triggers of the material elements of the construction model.

24) A method according to claim 22, wherein the method includes providing an event processor agent for:
a) receiving the event indication for the event;
b) processing the event indication in accordance with predetermined processing rules to determine one or material elements including triggers for one or more actions in response to the event; and,
c) causing the action to be performed.

25) A method according to claim 22, wherein the one or more actions include at least one of:
a) generating a task in the schedule;
b) generating a document;
c) modifying a document; and,
d) generating a notification.

26) A method according to claim 25, wherein the document is one of:
a) a quality assurance document;
b) a safety plan document;
c) a certification document;
d) an inspection document; and,
e) a contract document.

27) A method according to claim 25, wherein the method includes storing the document in a store.

28) A method according to claim 25, wherein the method includes delivering the document to a recipient selected based on a type of the document.

29) A method according to claim 25, wherein the document includes a barcode, the method including having a user scan the barcode to indicate compliance with the document.

30) A method according to claim 29, wherein the method includes:
a) obtaining details of a scanned barcode; and,
b) generating an event indication corresponding to the compliance with the document.

31) A method according to claim 1, wherein determining the one or more design customisations includes:
a) obtaining site details for a construction site for the construction project; and,
b) determining design customisations to allow construction project to be carried out on the construction site in accordance with the site details.

32) A method according to claim 1, wherein the construction model includes a hierarchical arrangement of material elements.

33) A method according to claim 32, wherein the construction model includes a plurality of sub-assemblies of material elements each representing a respective sub-assembly of materials for use in carrying out the construction project.

34) A method according to claim 33, wherein at least one design customisation relates to a sub-assembly, such that updating the building model in accordance with the at least one design customization includes at least one of:
a) adding one or more sub-assemblies of material elements;
b) removing one or more sub-assemblies of material elements; and,
c) modifying one or more sub-assemblies of material elements.

35) A method according to claim 1, wherein the method includes generating the construction information using a server processing system and providing the construction information to a user using a client processing system.

36) A method according to claim 35, wherein the method includes providing a web portal for allowing the user to interact with construction information relevant to the user.

37) A method according to claim 1, wherein the construction project is for at least one of:
a) constructing a new building;
b) renovating of an existing building;
c) incorporating an improvement to an existing building;
d) constructing a pool; and,
e) constructing landscaping.

38) A method according to claim 1, wherein the construction project includes work involving at least one of:
a) mechanical services;
b) electrical services;
c) plumbing;
d) roofing;
e) cabinet making;
f) air conditioning; and,
g) recladding.

39) Apparatus for managing a construction project, wherein the apparatus includes one or more electronic processing devices that:
a) for a selected standard construction design, retrieves a construction model for the standard construction design from a store, the construction model including a plurality of material elements representing materials for use in carrying out a construction project in accordance with the construction model, each material element having material properties including construction attributes;
b) determines one or more design customisations;
c) updates the construction model in accordance with the one or more design customisations to thereby generate a customised construction model, by at least one of:
i) adding one or more material elements;
ii) removing one or more material elements; and,
iii) modifying one or more material elements; and,
d) generates construction information associated with carrying out the construction project in accordance with the construction attributes of the customised construction model.

40) A method for managing a building construction project, wherein the method includes, in one or more electronic processing devices:
a) for a selected standard building design, retrieving a building model for the standard building design from a store, the building model including a plurality of material elements representing materials for use in constructing a building in accordance with the building model, each material element having material properties including construction attributes;
b) determining one or more design customisations;
c) updating the building model in accordance with the one or more design customisations to thereby generate a customised building model, by at least one of:
i) adding one or more material elements;
ii) removing one or more material elements; and,
iii) modifying one or more material elements; and,
d) generating construction information associated with construction of the building in accordance with the construction attributes of the customised building model.
